(19) United States
(12) Patent Application Publication
(10) Pub. No.: US 2016/0112501 A1
(43) Pub. Date: Apr. 21, 2016

(54) Transferring Device States Between Multiple Devices

(71) Applicant: Aaron Joseph Wheeler, San Francisco, CA (US)

(72) Inventor: Aaron Joseph Wheeler, San Francisco, CA (US)

(73) Assignee: GOOGLE INC., Mountain View, CA (US)

(21) Appl. No.: 13/407,994

(22) Filed: Feb. 29, 2012

(51) Int. Cl. H04L 29/08; H04L 12/18

(52) U.S. Cl. CPC H04L 67/104; H04L 12/1822

(57) ABSTRACT

Exemplary methods and systems relate to creating and loading a device-group snapshot, which allows the states of devices to be stored and restored by different devices. A hub system may create a device-group snapshot for a plurality of devices in a source device group and load the device-group snapshot to a target device group by: (a) receiving an instruction to load a device-group snapshot; (b) determining the target device group with devices that are available to load the device-group snapshot; (c) determining that there is a difference between device groups; (d) modifying the device-group snapshot based on the difference between device groups; and (e) communicating with devices in the target device group to load the corresponding device states from the modified device-group snapshot.

### BACKGROUND

Unless otherwise indicated herein, the materials described in this section are not prior art to the claims in this application and are not admitted to be prior art by inclusion in this section.

Computing devices such as desktop computers, laptop computers, tablet computers, personal digital assistants, cellular phones, and countless types of Internet-capable devices are increasingly prevalent in numerous aspects of modern life. Over time, the manner in which these devices are providing information to users is becoming more intelligent, more efficient, more intuitive, and/or less obtrusive.

Typically, these computing devices have been designed to perform specific functions and in many instances, users simply prefer using certain computing devices over others when completing particular tasks. For example, many users prefer searching the web with a laptop rather than using a cell phone and alternatively, most people prefer using a cell phone to make phone calls as opposed to using a laptop. Consequently, the use of more than one device to complete a single task is ever-more common.

### SUMMARY

In one aspect, a computer-implemented method is provided. The computer-implemented method may include receiving an instruction to load a device-group snapshot, where the device-group snapshot includes a device state for each of a plurality of devices in a source device group. Responsive to receipt of the instruction to load the device-group snapshot, the computer-implemented method may include determining a target device group with one or more devices that are available to load the device-group snapshot. Additionally, the computer-implemented method may also include determining that there is a difference between the target device group and the source device group. Furthermore, the computer-implemented method may include modifying the device-group snapshot based on the difference between the target device group and the source device group, where the modified device-group snapshot includes a device state for each of the devices in the target device group. Yet further, the computer-implemented method may include communicating with the one or more devices in the target device group to load the corresponding device states from the modified device-group snapshot.

In another aspect, a system is provided, according to an exemplary embodiment. The system may include a non-transitory computer-readable medium and program instructions stored thereon. Further, the program instructions may be executable by a processor to cause a hub system to receive an instruction to load a device-group snapshot, where the device-group snapshot comprises a device state for each of a plurality of devices in a source device group. Responsive to receipt of the instruction to load the device-group snapshot, the instructions may cause the hub system to determine a target device group with one or more devices that are available to load the device-group snapshot. Additionally, the hub system may determine that there is a difference between the target device group and the source device group. Furthermore, the hub system may modify the device-group snapshot based on the difference between the target device group and the source device group, where the modified device-group snapshot comprises a device state for each of the devices in the target device group. Yet further, the hub system may communicate with the one or more devices in the target device group to load the corresponding device states from the modified device-group snapshot.

In another aspect, a non-transitory computer readable medium is provided, according to an exemplary embodiment. The non-transitory computer readable medium may have program instructions stored, which are executable by a computing device. Further the program instructions may cause the computing device to perform functions such as receiving an instruction to load a device-group snapshot, where the device-group snapshot comprises a device state for each of a plurality of devices in a source device group. Responsive to receipt of the program instruction to load the device-group snapshot, the computing device may perform functions for determining a target device group with one or more devices that are available to load the device-group snapshot. Additionally, the program instructions may cause the computing device to perform functions for determining that there is a difference between the target device group and the source device group. Furthermore, the program instructions may cause the computing device to perform functions for modifying the device-group snapshot based on the difference between the target device group and the source device group, where the modified device-group snapshot comprises a device state for each of the devices in the target device group. Yet further, the program instructions may cause the computing device to perform functions for communicating with the one or more devices in the target device group to load the corresponding device states from the modified device-group snapshot.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1A is a block diagram illustrating a group of device groups, according to an exemplary embodiment.

FIG. 1B is another block diagram illustrating a group of devices, according to an exemplary embodiment.

FIG. 2 is a block diagram illustrating a device-group snapshot that may be created for the device group of FIG. 1B, according to an exemplary embodiment.

FIG. 3 is a flow chart illustrating a method 300, according to an exemplary embodiment.

FIG. 4A is a block diagram illustrating the same group of devices shown in FIG. 1A, but at a (first) later point in time, according to an exemplary embodiment.

FIG. 4B is a block diagram illustrating the same group of devices shown in FIG. 1A, but at a (second) later point in time, according to an exemplary embodiment.

FIG. 4C is a block diagram illustrating the same group of devices shown in FIG. 1A, but at a (third) later point in time, according to an exemplary embodiment.

FIG. 4D is a block diagram illustrating the same group of devices shown in FIG. 1A, but at a (fourth) later point in time, according to an exemplary embodiment.

FIG. 5A illustrates a first example system for receiving, transmitting, and displaying data, according to an exemplary embodiment.

FIG. 5B illustrates an alternate view of the system illustrated in FIG. 5A, according to an exemplary embodiment.

FIG. 6A illustrates a second example system for receiving, transmitting, and displaying data, according to an exemplary embodiment.

FIG. 6B illustrates a third example system for receiving, transmitting, and displaying data, according to an exemplary embodiment.

FIG. 7 illustrates a simplified block diagram of an example computer network infrastructure, according to an exemplary embodiment.

FIG. 8 illustrates a simplified block diagram depicting example components of an example computing system, according to an exemplary embodiment.

FIG. 9A illustrates aspects of an example user-interface, according to an exemplary embodiment.

FIG. 9B illustrates aspects of an example user-interface after receiving movement data corresponding to an upward movement, according to an exemplary embodiment.

FIG. 9C illustrates aspects of an example user-interface after selection of a selected content object, according to an exemplary embodiment.

FIG. 9D illustrates aspects of an example user-interface after receiving input data corresponding to a user input, according to an exemplary embodiment.

### DETAILED DESCRIPTION

Exemplary methods and systems are described herein. It should be understood that the word “exemplary” is used herein to mean “serving as an example, instance, or illustration.” Any embodiment or feature described herein as “exemplary” is not necessarily to be construed as preferred or advantageous over other embodiments or features. In the following detailed description, reference is made to the accompanying figures, which form a part thereof. In the figures, similar symbols typically identify similar components, unless context dictates otherwise.

Other embodiments may be utilized, and other changes may be made, without departing from the spirit or scope of the subject matter presented herein. The exemplary embodiments described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

### A. Overview

Devices that enable users to save the state of various applications open on the device have gained popularity. However, the ability to save and resume work sessions in a previous state is typically limited to a single device. Since a user may rely on multiple devices to complete a given task, a user may want to save device states of a number of devices in a common record, so that the device states can be restored on to other devices.

Accordingly, exemplary embodiments may involve a “device-group snapshot” that captures the respective device states of a number of devices at a given point in time. More specifically, a user such as a person, group of people (e.g., a family, friends, etc.) or business, may register or otherwise associate a number of different computing devices with an account and/or a profile. As such, a “device-group snapshot” (which may be referred to as a “DGS”) may be created to capture the respective states of a number of a user's devices (e.g., devices that are associated with the same account) at a given point in time. The device-group snapshot may then be restored (e.g., “loaded,” “returned,” “reestablished,” etc.) at a later time, so that the user can pick up their work where they left off. Herein, “loading” or “restoring” a device-group snapshot should be understood to involve a hub system sending instructions to one or more devices to load or restore respective states as indicated by the snapshot.

In some instances, a user might wish to load a device-group snapshot when some of the devices that were previously in use are no longer available and/or when devices that were previously unavailable are now available. Therefore, an exemplary embodiment may help to load a device-group snapshot on a group of devices that differs from the group of devices for which the device-group snapshot was created.

Accordingly, an exemplary embodiment may help to modify a device-group snapshot such that the device-group snapshot can be transferred to another device group that differs from the device group for which the snapshot was originally created. Herein, the device group for which a device-group snapshot is created may be referred to as the “source” device group (which may be referred to as a “SDG”), while the device group onto which a device-group snapshot is loaded at a later time may be referred to as the “target” device group (which may be referred to as a “TDG”). Thus, an exemplary embodiment may help to modify a device group based on the differences between a source device group and a target device group so that the device-group snapshot can be loaded on a target device group that differs from the source device group.

For example, a cloud-based system may store a device-group snapshot for a source device group that includes a cell phone, a laptop computer, and a tablet computer. The device-group snapshot could include device states that indicate: (a) that the cell phone is active on a call with a particular phone number, (b) that a presentation is open in a presentation-viewing application on the laptop computer, and (c) that a spreadsheet document is open on a spreadsheet-viewing application on the tablet computer.

By the time that the device-group snapshot is about to be restored, the cell phone may have moved to new location where, e.g., the cell phone's reception is limited. In addition, circumstances may have otherwise changed such that the user's laptop computer and tablet computer may have limited operability, perhaps due to low battery power. To continue working with the device states from the source device group, the device-group snapshot may be modified and loaded to a different set of devices that are currently available.

In particular, if the user's landline phone and desktop computer are available when the device-group snapshot is loaded, then the device states from the cell phone, laptop computer, and tablet computer may be modified such that they can be loaded on the landline phone and/or desktop computer. As a specific example, the call on the user's cell phone may be resumed on the user's landline phone (e.g., by receiving and dialing the phone number to which the ongoing call was placed). Further, both the presentation that was being displayed on the laptop computer and the spreadsheet document that was open on the tablet computer may be opened on the desktop computer (possibly after undergoing re-formatting to render the presentation and/or spreadsheet in an appropriate format).

As such, an exemplary method may help a user to quickly resume work on a project or task involving multiple devices. By modifying device states and/or portions of device states such as media content, application states, and other aspects of the device states associated with a source device group, the device states can then be restored (or at least approximately restored) on a target device group, in which one or more devices may be different. Of course, other benefits are possible as well.

It should be understood that the above applications of exemplary embodiments are provided for illustrative purposes, and are just a few of many possible applications of an exemplary embodiments.

### B. Exemplary Systems

An exemplary system may be implemented in, take the form of, or include a “hub system” that is configured to create and later restore a “device-group snapshot” for a group of devices associated with a given account. A hub system may be any computing device that is configured to receive state information from other devices, and to facilitate creation and/or restoration of a device-group snapshot for the other devices. In some cases, the hub system may itself be part of a device group for which a device-group snapshot is created. In other cases, the hub system may be separate from devices that are associated with an account. For example, the hub system may be a server system (e.g., a cloud-based server), which communicates with other devices in order to create a device-group snapshot for the other devices.

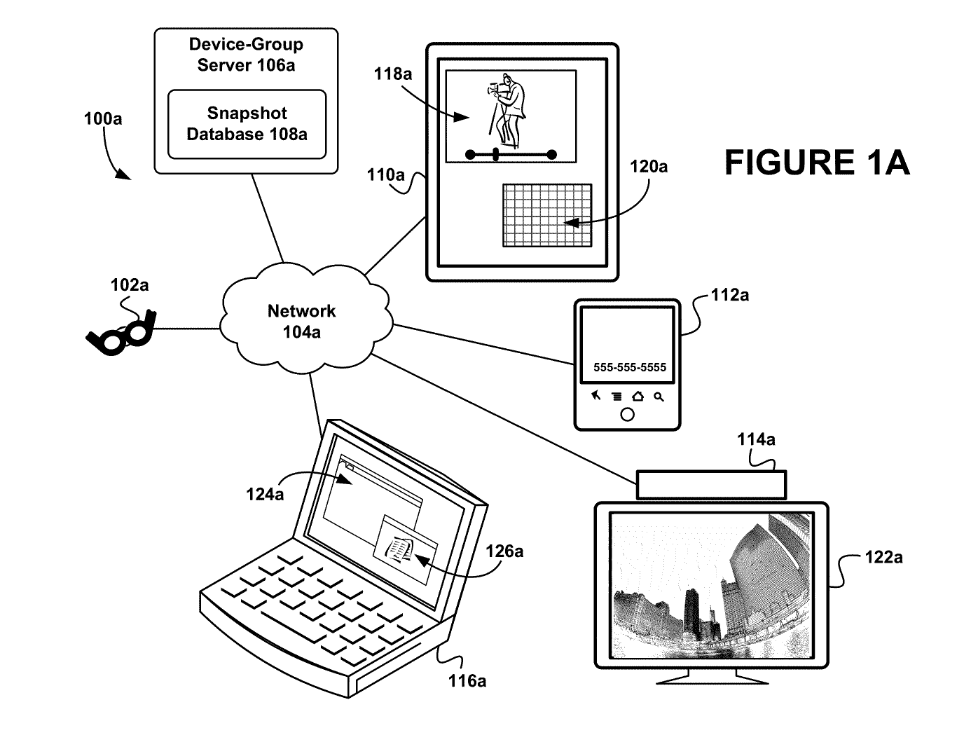

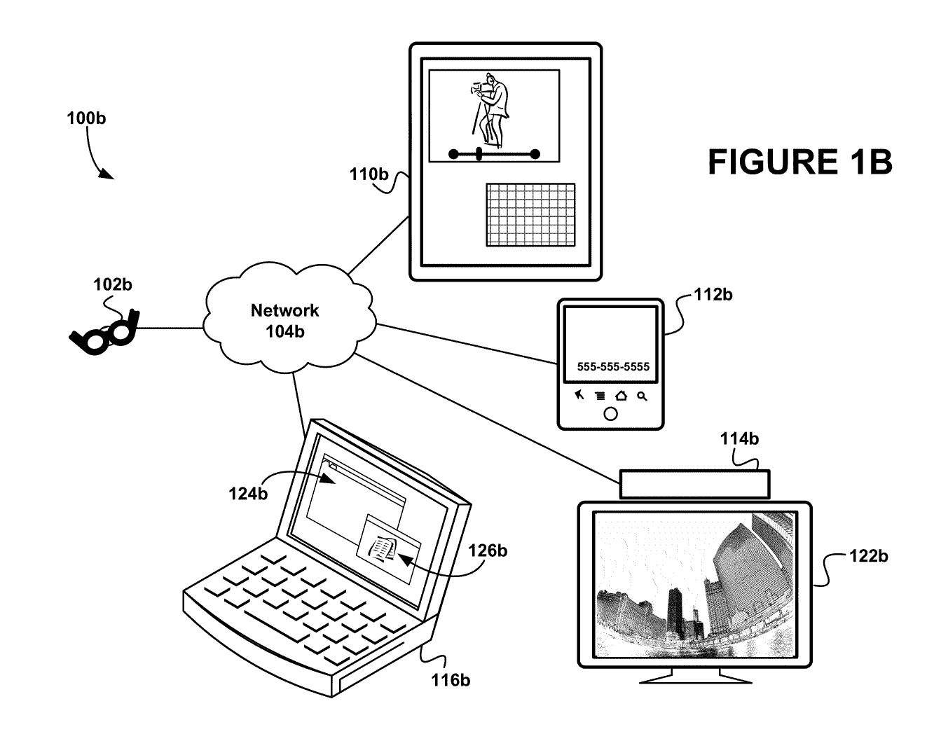

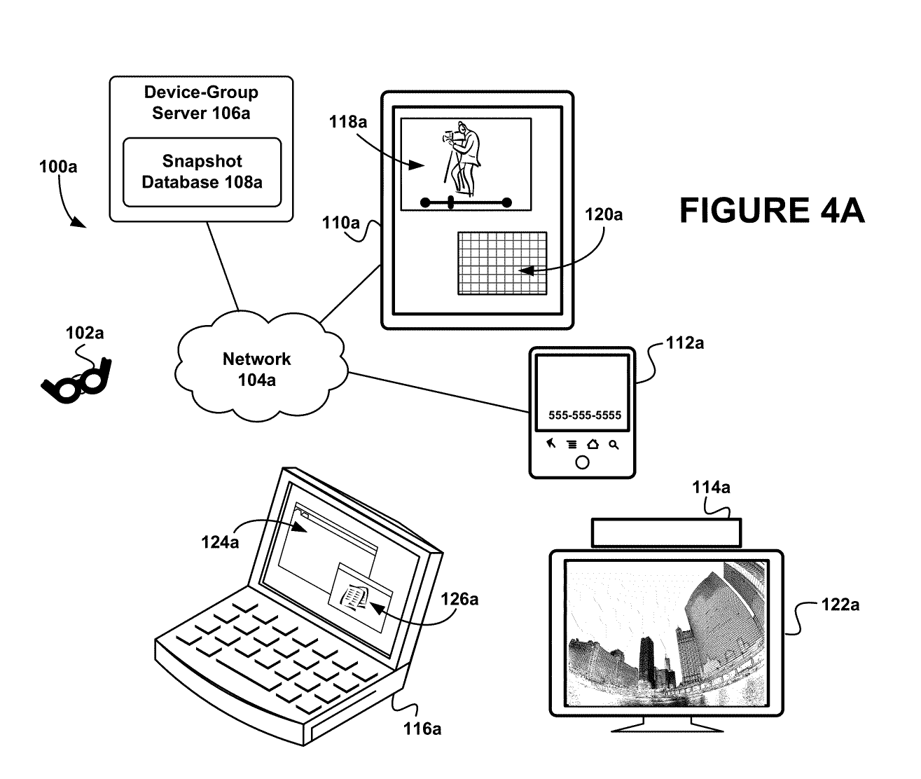

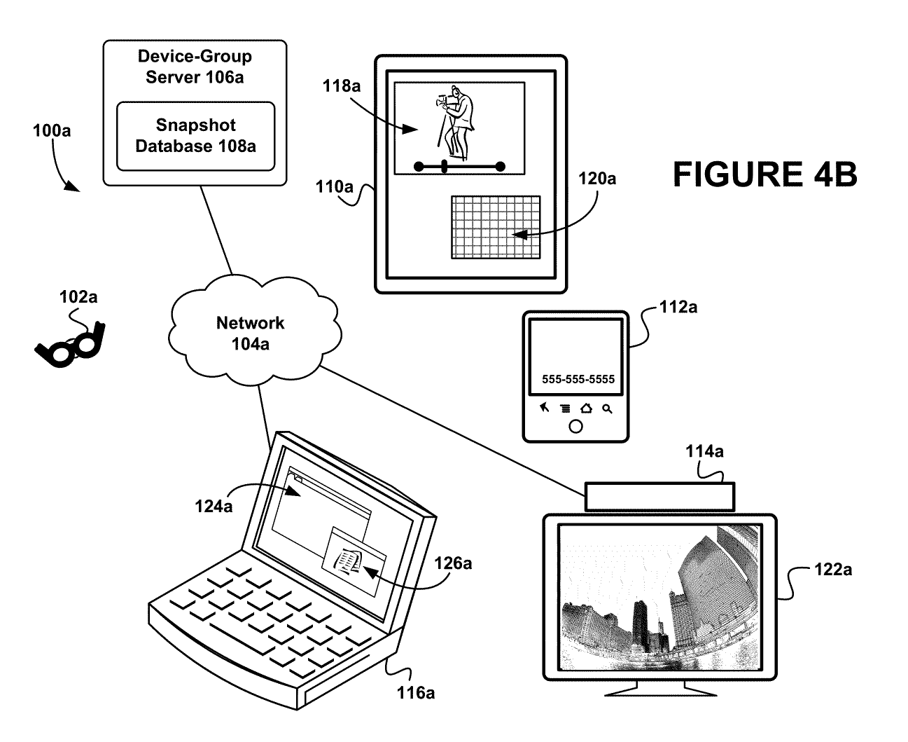

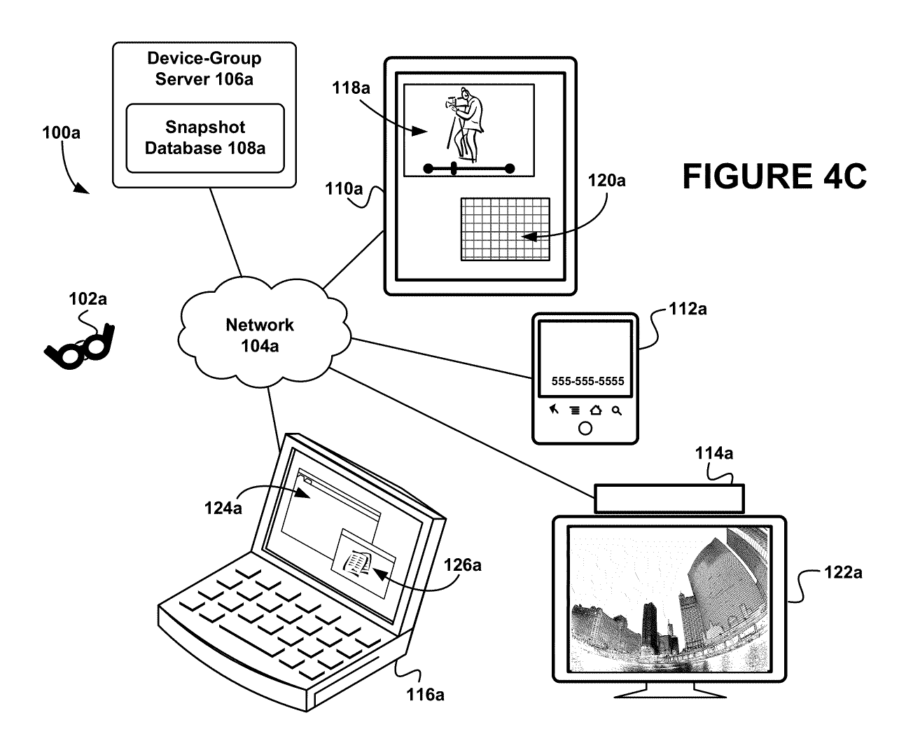

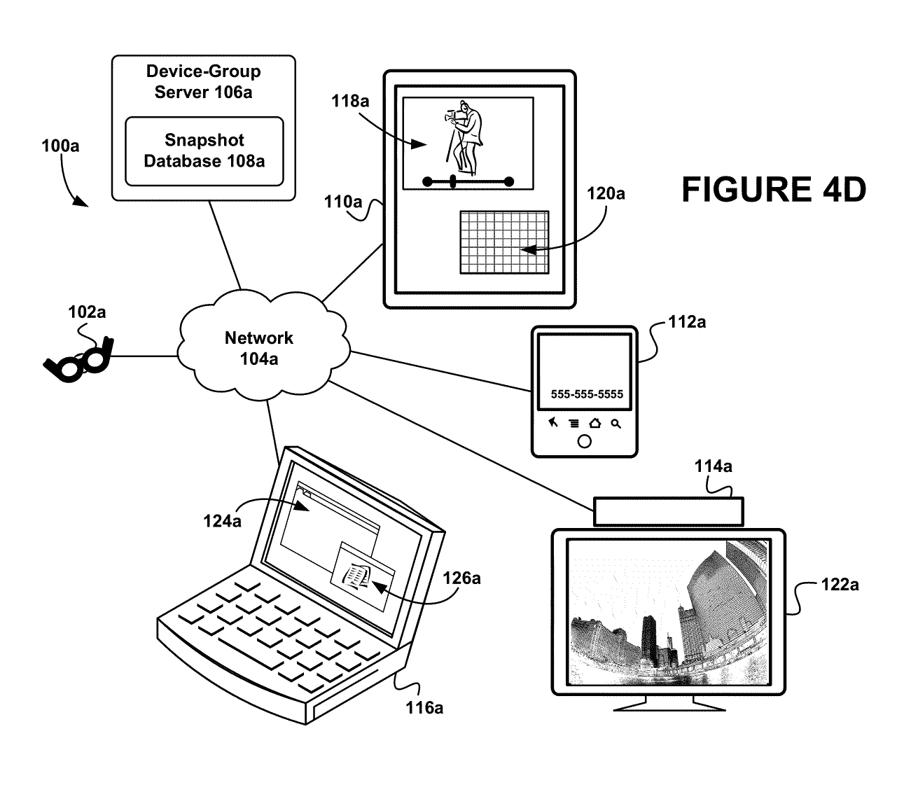

FIG. 1A is a block diagram illustrating a group of devices, according to an exemplary embodiment. In particular, FIG. 1A shows device-group 100a including wearable computer 102a, tablet computer 110a, smartphone 112a, television receiver 114a, laptop computer 116a. Further, FIGS. 4A-4D also show device-group 100a, but FIGS. 4A-4D show device-group 100a at different times. Thus, FIGS. 4A-4D also show wearable computer 102a, tablet computer 110a, smartphone 112a, television receiver 114a, and laptop computer 116a.

As shown in FIG. 1A, some or all of these devices may be configured to communicate with each other via one or more networks 104a. It should also be understood that a device group may include various other types of devices, and generally may include any sort of computing device such as a network terminal, a printer, a desktop computer, and/or a set-top box, among others, without departing from the scope of the embodiments herein.

Further, FIG. 1A illustrates an arrangement in which a remote server system, e.g., device-group server 106a, acts as a hub system that facilitates the creation and restoration of device-group snapshots. Thus, as shown, device-group server 106a sits as a node on network 104a, and includes or has access to a device-group snapshot database 108a. Device-group server 106a may also include or have access to an account database (not shown), which may include data indicating which devices are associated with certain accounts (e.g., a user's account). For instance, a record in such an account database may indicate that wearable computer 102a, tablet computer 110a, smartphone 112a, television receiver 114a, and laptop computer 116a (and these devices at later points in time as described above for FIGS. 4A-D) are all associated with the same account. As such, device-group server 106a may facilitate creating device-group snapshots for groups of devices from a given account. For example, a device-group snapshot may be created for a source device group that includes wearable computer 102a, laptop computer 116a, and television receiver 114a.

Further, device-group server 106a may be configured to modify a device-group snapshot so as to help load the device-group snapshot to a target device group that differs from the source device group from which the snapshot was created. For example, consider the above-described scenario where a device-group snapshot has been created for a source device group that includes wearable computer 102a, laptop computer 116a, and television receiver 114a.

When device-group server 106a is about to load this device-group snapshot, it may determine that wearable computer 102a, laptop computer 116a, and television receiver 114a are not available, and that the only available devices from the same account are tablet computer 110a and smartphone 112a. Therefore, tablet computer 110a, and smartphone 112a may be considered to be included in the target device group on which the device-group snapshot should be restored. Accordingly, device-group server 106a may modify the device states indicated by the device-group snapshot such that they can be restored on the target device group.

In some embodiments, a server (possibly such as device-group server 106a) may include programs to “serve” requests for various client devices. For example, a server may run programs originally started on client devices and run these programs remotely on behalf of the client devices. Such embodiments of remote processing may be advantageous in instances where the server maintains features more suitable for production environments. For instance, a server may include a faster CPU, increased high-performance RAM, and increased storage capacity (e.g., larger hard drives) to perform processing more efficiently than client devices. In addition, servers generally have fault tolerant features such as redundant power supplies and fallback network connections to ensure reliability in remote processing.

FIG. 1B is another block diagram illustrating a group of devices, according to an exemplary embodiment. Further, FIG. 1B illustrates an arrangement where a given device from an account serves as the hub system. As shown, device group 100b includes wearable computer 102b, a tablet computer 110b, a smartphone 112b, television receiver 114b, and laptop computer 116b. All the devices may configured to communicate via a network 104b. It should also be understood that a device group may include various other types of devices, and generally may include any sort of computing device such as a network terminal, a printer, a desktop computer, and/or a set-top box, among others, without departing from the scope of the embodiments herein.

Additionally or alternatively, some devices in a device group may be configured to communicate with other devices in other device groups via different networks and/or multiple networks (not shown). Further, some or all devices may be configured to communicate with one another via direct connections (e.g., via Bluetooth, Wireless USB, and/or ultra-wideband).

In FIG. 1B, wearable computer 102b may be configured to serve as the “hub system” within a device group as opposed to, for example, a server system (i.e. device-group server 106a) as illustrated in FIG. 1A. Further, the device group in FIG. 1B includes some or all of wearable computer 102b, tablet computer 110b, smartphone 112b, television receiver 114b, and laptop computer 116b. However, it should be understood that other devices in device group 100b may be configured to provide the hub-system functionality described herein, in addition or alternatively to wearable computer 102b. Further, other devices may also be included in device group 100b at different times (not shown) which may also be configured to provide hub-system functionality.

As the hub system for device group 100b, wearable computer 102b may be configured to create a device-group snapshot. The device-group snapshot may include state records for some or all the devices in device group 100b. For instance, when wearable computer 102b creates a device-group snapshot for device group 100b, the snapshot may include state records for some or all of wearable computer 102b, a tablet computer 110b, a smartphone 112b, television receiver 114b, and laptop computer 116b.

Further, wearable computer 102b may be configured to modify the device-group snapshot so as to help load the device-group snapshot to a target device group that differs from the source device group for which the snapshot was created. Yet further, wearable computer 102b may be configured to restore a device group on a target device group including some or all of wearable computer 102b, a tablet computer 110b, a smartphone 112b, television receiver 114b, and laptop computer 116b.

For example, consider a device-group snapshot that includes state information for the wearable computer 102b, television receiver 114b, and laptop computer 116b. When wearable computer 102b is about to load this device-group snapshot, it may determine that television receiver 114b and laptop computer 116b are unavailable, while tablet computer 110b has now become available. Accordingly, wearable computer 102b and tablet computer 110b may be considered to be the target device group on which the device-group snapshot should be loaded. Accordingly, wearable computer 102b may modify the device states indicated by the device-group snapshot such that they can be restored on the target device group.

Further, in another example referring back to FIG. 1A, consider a device-group snapshot that includes state information for the wearable computer 102a, laptop computer 116a, and television receiver 114a. Before loading the device-group snapshot, device-group server 106a may determine that television receiver 114a and laptop computer 116a are unavailable, and also determine that tablet computer 110a has become available. Wearable computer 102a may then send data indicating the availability (or unavailability) of these devices to device-group server 106a. Upon receiving such data, device-group server 106a may modify the device-group snapshot for restoring the device-group snapshot on the target device group.

Further, it should be understood that the above examples are provided for illustrative purposes and that a device-group snapshot may be created by and/or restored by various types of other devices, or combinations of devices, other than those discussed explicitly herein. Further, a device-group snapshot may be created by capturing device states for a number of other devices also not shown, without departing from the scope of the embodiments herein.

### C. Exemplary Device-Group Snapshots

In one application of an exemplary embodiment, the wearable computer 102a may create a device-group snapshot that includes state records corresponding to the states of devices including tablet computer 110a, smartphone 112a, television receiver 114a, laptop computer 116a (and possibly a state record for itself as well).

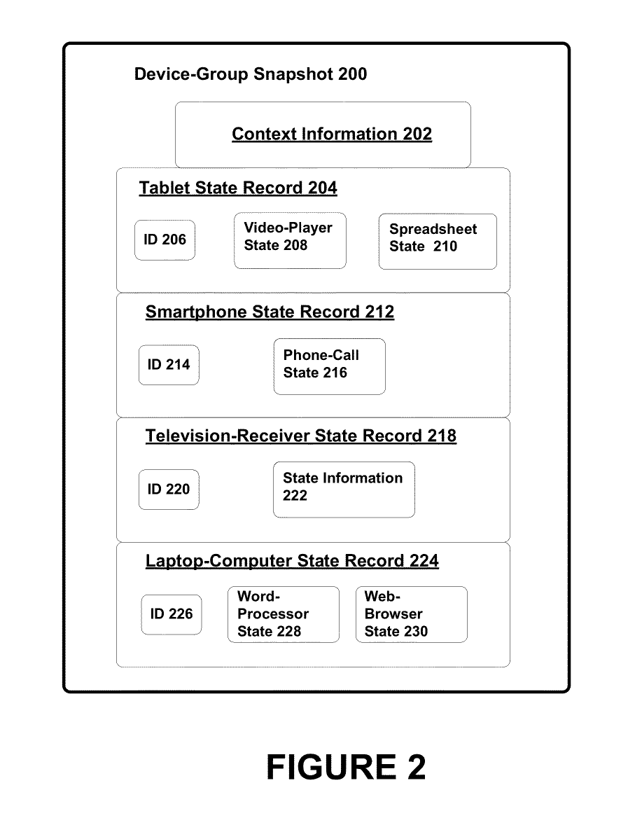

For example, FIG. 2 is a block diagram illustrating a device-group snapshot that may be created for the device group of FIG. 1A, according to an exemplary embodiment. More specifically, device-group snapshot 200 includes a tablet state record 204 (corresponding to the state of tablet 110a), smartphone state record 212 (corresponding to the state of smartphone 112a), television-receiver state record 218 (corresponding to the state of television receiver 114a), and laptop-computer state record 224 (corresponding to the state of laptop computer 116a). Device-group snapshot 200 may also include contextual information 202, which may indicate a context that is associated with the device-group snapshot 100a. However, it should be understood that context information 202 is shown in device-group snapshot 100b for illustrative purposes and that in some embodiments, there may be no context information included in a device-group snapshot.

Each state record in device-group snapshot 200 includes a device identifier (ID), which uniquely identifies that device to which the record corresponds. In particular, tablet state record 204 includes a device ID 206, smartphone state record 212 includes a device ID 214, television-receiver state record 218 includes a device ID 220, and laptop-computer state record 224 includes a device ID 226.

Further, each state record in device-group snapshot 100a may include data indicating the state of the respective device when the snapshot was created. For example, tablet state record 204 includes video-player state information 208 (corresponding to the state of video player application 118a) and spreadsheet state information 210 (corresponding to the state of spreadsheet application 120a). The video-player state information 208 may indicate, for example, the identity and/or storage location of the particular video that was open, the time elapsed in the video, the time remaining in the video, the identity and/or storage location of a playlist including the video (if the video was being played in the course of playing back a playlist), and/or other state information relating to video-player application 118a. The spreadsheet state information 210 may indicate, for example, the identity and/or storage location of the particular spreadsheet document that was open and/or other state information relating to spreadsheet application 120a.

Further, smartphone state record 212 includes phone-call state information 216, which may indicate that smartphone 112a which engaged in a call to the phone number “555-555-5555” when the device-group snapshot 100a was created. Further, if the smartphone 112a had applications running in the background when the snapshot 100a was created, smartphone state record 112a may include state information (not shown) that indicates the respective states of these applications.

Yet further, television-receiver state record 218 includes state information 222 indicating the state of television receiver 114a at or near the creation of device-group snapshot 200. In particular, state information 222 may indicate the particular television channel that was being outputted for display on a television (corresponding to television device state 122a). For example, state information 222 may indicate, the channel number, the name of and/or information related to the particular program that was on the channel at the time, the elapsed and/or remaining time in the particular program, and possibly other information as well. Further, state information 222 may also include information related to the recording via the DVR application, such as the channel number and the name of and/or information related to the particular program that was being recorded.

And yet further, laptop-computer state record 224 includes word-processor state information 228 (corresponding to the state of word-processor application 126a) and web-browser state information 230 (corresponding to the state of web-browser application 124a). The word-processor state information 228 may indicate the particular document that is open in word-processor application 126a (e.g., the file name and/or the file storage location of the document), and possibly other state information related to word-processor application 126a as well. The web-browser state information 230 may indicate the URL of the webpage that is open in each tab of web-browser application 124a, and possibly other state information related to web-browser application 124a as well.

### D. Exemplary Methods for Restoring a Device-Group Snapshot on a Differing Target Device Group

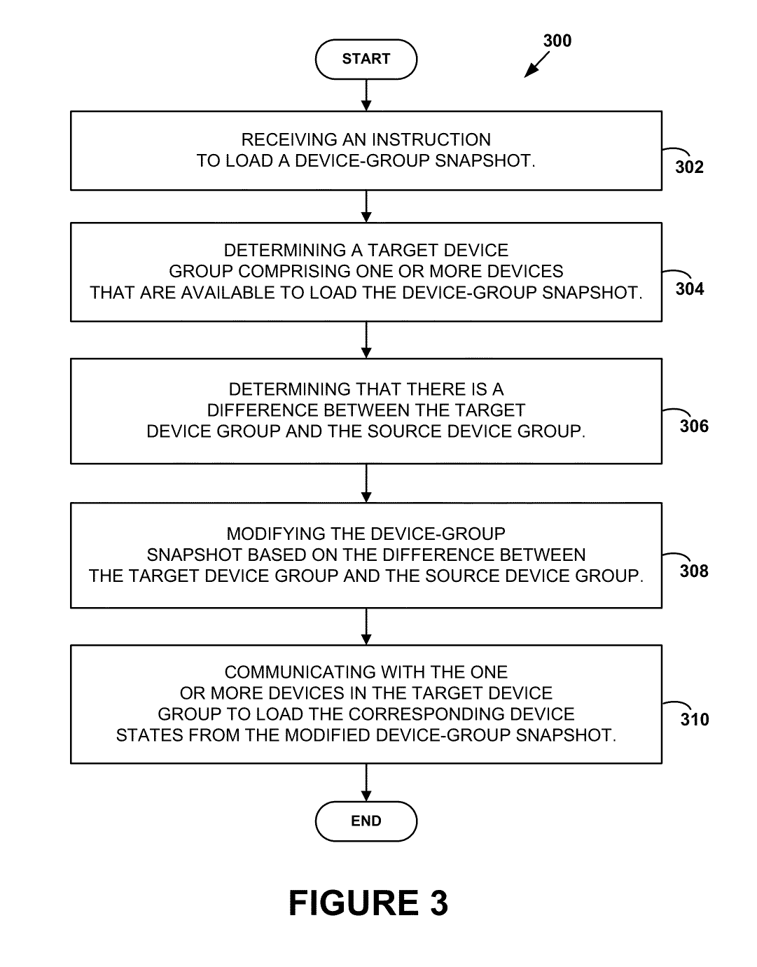

FIG. 3 is a flow chart illustrating a method 300, according to an exemplary embodiment. In FIG. 3, method 300 is described by way of example as being carried out by a hub system, such as device-group server 106a that is illustrated in FIG. 1A or wearable computer 102b that is illustrated in FIG. 1B. However, it should be understood that exemplary methods, such as method 300, may be carried out by other systems, sub-systems, networks, and/or through combinations thereof, without departing from the scope of the embodiments herein.

As shown by block 302, method 300 involves a hub system receiving an instruction to load a device-group snapshot, where the device-group snapshot includes a device state for each of two or more devices in a source device group. Responsive to receipt of the instruction, the hub system may determine a target device group, which may include one or more devices that are available to load the device-group snapshot, as shown by block 304.

The hub system may determine a difference between the target device group and the source device group, as shown by block 306. The hub system can further modify the device-group snapshot based on the difference between the target device group and the source device group, as shown by block 308. In an exemplary embodiment, the modified device-group snapshot may include a device state for each of the devices in the target device group. Upon modifying the device-group snapshot for the target device group, the hub system may communicate with the devices in the target device group to indicate that devices should load their respective device states from the modified device-group snapshot, as shown by block 310.

i. Initialization of an Exemplary Method

In some implementations, an exemplary method may be initiated upon receipt of an instruction from a user of a computing device. Accordingly, block 202 may involve the hub system receiving an instruction from a user's computing device. For example, in FIG. 1A, an application running on wearable computer 102a may allow a user to request that a device-group snapshot be created and/or restored. Accordingly, the application may cause an instruction to create or restore a device-group snapshot to be sent to the device-group server 106a. In response, device-group server 106a may initiate an exemplary method in order to restore the device-group snapshot.

In some implementations, an exemplary method may be initiated upon detecting a certain context. For example, devices from a device group may identify and/or receive various context signals, which may be used to determine a current context of a device or devices in the device group. Note that the context associated with a given device or devices may serve as a proxy for the context of a user that is associated with the devices (e.g., the owner or a registered user of a device). (Further examples of how context may be determined are provided in the sections described as “Modifications Based on Context” and “Utilizing Context” below.) As such, when a certain context is detected, the hub system may responsively restore a device-group snapshot that corresponds to the certain context.

Further, in order to determine which device-group snapshot should be restored in a certain context, a hub system may include or have access to context-to-snapshot mapping data, which maps certain contexts (or certain context signals or combinations of context signals) to certain device-group snapshots. As such, the hub system may use the context-to-snapshot mapping data to determine whether the current context is mapped to a device-group snapshot. Thus, when the hub system detects a context to which a certain device-group snapshot is mapped, the hub system may responsively implement an exemplary method to load the device-group snapshot.

In some cases, the hub system may initiate an exemplary method to load a device-group snapshot based on its own context. For example, a wearable computer serving as a hub system may monitor its own context signals and determine a current context based on these context signals. Further, the wearable computer may compare its context to context-to-snapshot mapping data, and responsively load a device-group snapshot that is mapped to its current context. Alternatively, if the wearable computer determines that device-group snapshot corresponding to its current context should be loaded, the wearable computer may request that a remote entity, such as device-group server 106a, load the appropriate device-group snapshot.

In other cases, the hub system may initiate an exemplary method to load a device-group snapshot in response to the context of another device or devices. For example, device-group server 106a may receive context signals and/or identify a context from an end-user device or devices, such as wearable computer 102a, tablet computer 110a, smartphone 112a, television receiver 114a, and laptop computer 116a. Device-group server 106a may then use the provided context information and a context-to-snapshot mapping data to determine whether a device-group snapshot corresponds to the provided context information, and if so, load the corresponding device-group snapshot.

In some implementations, an exemplary method may be initiated in response to detecting a certain “change in context”. For example, devices from a device group may identify and/or receive different context signals over time. Such context signals may be used to determine a change in context of one or more devices in the device group. In some instances, a change in context may be defined by changes between values of one or more context signals. Further, in some instances, a change in context may be defined by changing from one context mapped to a respective device-group snapshot to another context mapped to a different device-group snapshot (as provided by context-to-snapshot mapping data noted above). Other possibilities may also exist.

Further, in some examples, a change in context may indicate changes to the environment or state information such as moving from “home” to “at work,” from “outside” to “in a car,” from “outdoors” to “indoors,” from “inside” to “outside,” from “free” to “in a meeting,” etc. In some instances, a change in context may indicate an action indicative of changes to the environment or state information such as “going to work,” “getting in the car,” “going inside,” “going outside,” “going to a meeting,” etc.

It should be understood that the above examples are provided for illustrative purposes, and an exemplary method may be initiated by other means including, but not limited to, other stimuli and/or information provided by one or more other devices (possibly not within a particular device group.) Further, instructions to initiate a method may be received from various other sources, including other users. Other possibilities may also exist.

ii. Determining a Target Device Group

Responsive to receiving the instruction to load the device-group snapshot, method 300 further involves the hub system determining the target device group, as shown by block 304.

In some embodiments, a target device group, or at least a portion thereof, may be based at least in part on an instruction from an end-user computing device, which indicates a certain device or devices that the user would like to have included in the target device group. For example, an application running on a wearable computer may provide a user with options to request specific devices (from devices associated with the user's account) to be included in a target device group.

Further, in some embodiments, after making such requests, the application may then send an indication of the requested devices to a hub system. In some instances, the hub system may perform evaluations between the device-group snapshot and each user-selected device, perhaps analyzing the technical specifications of the devices. Further, in some instances, the hub system may evaluate the devices to determine which, if any, of the devices are technically capable of uploading certain device states.

Note, however, that in some instances, a device that is requested by a user may not be available. Accordingly, the hub system may further check whether a user-selected device is available before including it in the target device group.

In some embodiments, to determine which devices to include in the target device group, a hub system may determine which devices are currently available. For example, the hub system may identify which devices have network connectivity, and can thus be instructed to restore the respective states indicated by the device-group snapshot. To do so, when a hub system restores a device-group snapshot, it may send a message to the devices in the source device group (and possibly other devices from the same account as the source device group). If a given device is available, then the device may respond with an acknowledgement (ACK) message. Therefore, in a basic implementation, the hub system may consider all devices from which an ACK is received to be part of the target device group.

In some instances, criteria other than network connectivity may additionally or alternatively be used to determine which devices are currently available. To illustrate, a server system may retrieve information indicative of a device's remaining battery life, ability to send and/or receive data (e.g., current available bandwidth and/or maximum possible bandwidth), network-connectivity status, and/or operating mode (e.g., whether the device is on, off, in stand-by mode, sleep mode, or busy mode).

In some embodiments, a device's availability may be based, at least in part, on the device's proximity to another device or devices from the same account. For example, a device may be considered to be available when it is within a certain distance of a device that is likely to be with a user. More specifically, certain devices such as a wearable computer may be considered to provide an estimate of a wearer's location, and it may be desirable for devices in the target device group to be with or near the wearer. Accordingly, a device may not be considered available to be in the target device group unless it is located within a certain distance from a wearable computer or another device considered likely to be with a user.

For example, in FIG. 1A, device-group server 106a may send an instruction (e.g., through network 104a) to laptop computer 116a directing laptop computer 116a to communicate with wearable computer 102a through close-proximity protocols (e.g., attempt to receive an ACK from wearable computer 102a). Thereafter, laptop computer 116a may request wearable computer 102a to send an ACK through Bluetooth, radio-frequency identifier (RFID), protocols such as near-field communications (NFC), among other possibilities. Upon receiving an ACK from wearable computer 102a, laptop computer 116a may communicate to device-group server 106a that it did receive the ACK. Therefore, device-group server 106a may recognize that laptop computer 116a is in close proximity to wearable computer 102a. Further, since wearable computer 102a is generally operated while being worn by the user, device-group server 106a may also recognize that both devices are proximate to the user.

In some embodiments, the hub system may first narrow down the candidate devices for the target device group by identifying which devices are desirable for the target device group. The hub system may then determine if the desired devices are available, rather than checking on all possible devices from the given account for their availabilities. For instance, a hub system may receive an instruction (e.g., from an end-user device) that indicates a certain device or devices that should be included in the target device group, if possible. It should be understood that desirable devices may also be identified based on other factors.

For example, in some cases, the hub system may recognize that certain devices are desirable for the particular states that are to be restored. For instance, in FIG. 1A, device-group server 106a may recognize that television receiver 114a is more desirable to restore a television show as opposed to, for instance, smartphone 112a (e.g., due to smartphone 112a's limited network connectivity and/or bandwidth to stream videos).

Further, in some instances, for identifying which devices are currently available, device-group server 106a may retrieve information related to television receiver 114a's television set (e.g., its screen dimensions). Yet further, in some instances, device-group server 106a may retrieve information regarding smartphone 112a to make an assessment of its availability. For example, device-group server 106a may recognize that smartphone 112a is running low on battery power such that it cannot adequately stream videos for a given time period (e.g., the remaining time period left in a video to be played). Therefore, device-group server 106a may determine that television receiver 114a is more desirable to restore the television show through television receiver 114a.

In another example, the hub system may determine that certain devices are desirable in certain contexts and/or for the particular states that are to be restored in certain contexts. For instance, consider an example such that the user is on a bus with wearable computer 102a, and wants to restore a television show that was previously stored to a device-group snapshot. Although device-group server 106a may determine television receiver 114a is most desirable to restore the television show, device-group server 106a may also recognize (e.g., based on context signals received from wearable computer 102a) that the user is operating wearable computer 102a on a moving bus and that the user is not in close proximity to television receiver 114a. Therefore, device-group server 106a may restore the television show onto wearable computer 102a instead.

It should be understood that the examples described above are provided for illustration and that other factors may be weighed to determine a target device group (e.g., which devices are desirable devices for a target device group). Further, upon recognizing a desirable device based on a factor which may not described above, such a device may then be searched to determine current availability (e.g., network connectivity). Upon establishing that the device is available, then the device may be included in the target device group. Other possibilities may exist without departing from the scope of the embodiments herein.

iii. Exemplary Differences Between the Source and Target Device Groups

As noted above, method 300 may involve a hub system determining that there is a difference between the target device group and the source device group, as shown by block 306. This may involve various types of differences. For example, the target device group may not include a device or devices from the source device group (e.g., devices from the source device group may no longer be available). Further, the target device group may include an additional device or devices that were not part of the source device group. When the target device group includes an additional device, the target device group may be considered to be different from the source device group when some or even all devices from the source device group remain in the target device group. On the other hand, the target device group may be entirely different from the source device group, with none of the same devices.

As noted, in some instances, the target device group may be entirely different from the source device group (i.e., when none of the devices in the target device group were in the source device group). For example, as noted, FIG. 4A is a block diagram illustrating the same group of devices shown in FIG. 1A, but at a later point in time. Further, referring back to FIG. 1A, consider a device-group snapshot for a source device group that includes wearable computer 102a, laptop computer 116a, and television receiver 114a. At the later time illustrated in FIG. 4A, none of the devices from the source device group are available, as indicated by the lack of connections (i.e. lines) between each of wearable computer 102a, laptop computer 116a, and television receiver 114a, and network 104a. However, tablet computer 110a and smartphone 112a are available.

Therefore, if a device-group snapshot is loaded at the point in time illustrated by FIG. 4A, the tablet computer 110a and cell phone 112a may be included in the target device group, which notably does not include any of the same devices as the source device group.

Differences may also exist when some or all of the devices from the source device group remain in the target device group. In this case, (a) the target device group may include only a subset of the devices from the source device group (i.e., when one or more devices are no longer be available in the target device group, and no additional devices are included in the target group), (b) the target device group may include a subset of the devices from the source device group, as well as one or more additional, or (c) the target device group may include the entire source device group and one or more additional devices as well.

As noted, in some instances, the target device group includes only a subset of the devices from the source device group (i.e. not all devices in the source device group are in the target device group). For example, FIG. 4B is a block diagram illustrating the same group of devices shown in FIG. 1A, but at a later point in time. Further, referring back to FIG. 1A, consider again the device-group snapshot for a source device group including wearable computer 102a, laptop computer 116a, and television receiver 114a. At the later time illustrated in FIG. 4B, wearable computer 102a is no longer available. However, laptop computer 116a and television receiver 114a are still available.

Therefore, if a device-group snapshot is loaded at the point in time illustrated by FIG. 4B, laptop computer 116a and television receiver 114a may be included in the target device group (i.e. a subset of devices from the source device group). In this scenario, the target device group is a subset of the devices from the source device group, as it includes some devices from the source device group, but does not include any additional devices that were not in the source device group.

Further, in some instances, the target device group includes both a subset of the devices from the source device group and one or more additional devices. For example, FIG. 4C is a block diagram illustrating the same devices shown in FIG. 1A, but at a later point in time. Further, referring back to FIG. 1A, consider again the device-group snapshot for a source device group including wearable computer 102a, laptop computer 116a, and television receiver 114a. At the later time illustrated in FIG. 4C, the wearable computer 102a is no longer available. However, laptop computer 116a and television receiver 114a are still available (i.e. a subset of devices from the source device group). Furthermore, tablet computer 110a and cell phone 112a, which were not included in the source device group, are now available (i.e. one or more additional devices).

Therefore, if a device-group snapshot is loaded at the point in time illustrated by FIG. 4C, the target device group may include laptop computer 116a, television receiver 114a, tablet computer 110a and smartphone 112a. In this scenario, the target device group includes both a subset of the devices from the source device group, as well as additional devices that were not included in the source device group.

Yet further, in some instances, the target device group includes the entire source device group as well as one or more additional devices. For example, FIG. 4D may illustrate the same devices shown in FIG. 1A, but at a later point in time. Further, referring back to FIG. 1A, consider again the device-group snapshot for a source device group including wearable computer 102a, laptop computer 116a, and television receiver 114a. At the later time illustrated in FIG. 4D, wearable computer 102a, laptop computer 116a, and television receiver 114a (i.e. entire source device group) are all still available. Furthermore, tablet computer 110a and cell phone 112a, which were not included in the source device group, are also now available (i.e. additional devices).

Therefore, if a device-group snapshot is loaded at the point in time illustrated in FIG. 4D, the target device group may include wearable computer 102a, laptop computer 116a, television receiver 114a, tablet computer 110a and smartphone 112a. In this scenario, the target device group includes all the devices from the source device group, and also includes additional devices, which were not included in the source device group.

It should be understood that the above examples are provided for illustrative purposes and other combinations or sub-combinations of differences between the source device group and the target device group may also exist without departing from the scope of the embodiments herein.

iv. Modifying the Device-Group Snapshot

As noted above, method 300 may involve a hub system (e.g., a server system) modifying the device-group snapshot based on the difference between the target device group and the source device group, as shown by block 308. Generally, the device-group snapshot may be modified in an effort to transfer, convert, or represent the stored states of the devices in the source device group on the devices in the target device group (to the extent possible). However, it should be understood that the device-group snapshot may be modified for other purposes, without departing from the scope of the embodiments herein.

As noted, the modification of the device-group snapshot may depend, at least in part, on what the difference is between the source device group and the target device group. For instance, if one or more devices from the source device group are not included in the target device group, then device-group snapshot may be modified so as to account for these “missing” devices, to the extent feasible. Additionally or alternatively, when additional devices are included in the target device group (that were not in the source device group), the features and/or capabilities of the additional devices may be accounted for when modifying the device-group snapshot. The hub system could also consider other differences between the source device group and the target device group when modifying the device-group snapshot.

a. Modifications to Help Account for Missing Devices

When modifying a device-group snapshot, a hub system may use various techniques to account for missing devices. For example, the hub system may remove the state record for each of these “missing” devices, while also creating and/or updating the state record for at least one device in the target device group with state information corresponding to that of the missing device(s). (Alternatively, rather than removing the state record for the missing device, the state record may be converted for and/or re-associated with a device or devices in the target device group.)

As a specific example, consider a source device group that includes a desktop computer (and one or more other devices), as well as a device-group snapshot for the source device group in which the state record for the desktop computer indicates a spreadsheet file was open in a spreadsheet application. In an exemplary scenario, the target device group for the device-group snapshot may not include the desktop computer, but may include a tablet computer. Accordingly, the device-group snapshot may be modified so as to include a state record that provides an indication for tablet computer to open the same spreadsheet file (or possibly a converted version) in a spreadsheet application that is available on the tablet computer. Note that the tablet computer's spreadsheet application may be the same as or different from the spreadsheet application that was being used on the desktop computer. Accordingly, to modify the device-group snapshot, the hub system may convert the spreadsheet to a different file format, and/or modify the spreadsheet file in other ways, so that the spreadsheet file can be displayed on the tablet computer.

Note that many scenarios exist where the devices in the target device group may not be able to provide the same functionality (e.g., a lower level of functionality) as those in the source device group. However, in such cases, the device-group snapshot may be modified in an effort to approximate the functionality of the source device group and/or in an effort to provide partial functionality.

For example, consider a source device group that includes a desktop computer (and one or more other devices), as well as a device-group snapshot for the source device group in which the state record for the desktop computer indicates a spreadsheet open in a spreadsheet application. In an exemplary scenario, the target device group for the device-group snapshot may not include the desktop computer, but may include a cell phone. Accordingly, the device-group snapshot may be modified to provide an indication for the cell phone to open the spreadsheet on the cell phone's spreadsheet-viewing application (which may not have editing capabilities). Although the spreadsheet may not be edited on the cell phone, the cell phone may be the most desirable device that can upload the spreadsheet under the circumstances.

Further, note that in many scenarios, there may be more than one candidate device for re-creating a state record from a missing device. In such cases, logic may be applied to select one of the candidate devices over the others. For example, consider the scenario above, however, further contemplate that the target device group not only includes the cell phone, but also includes a tablet computer. Accordingly, logic may be applied to select tablet computer over the cell phone because the tablet computer may have a larger viewing screen and possibly may allow for editing the spreadsheet in a different (e.g., more user-friendly) application that what may be offered by the cell phone. Thereafter, the device-group snapshot may be modified so as to provide an indication for the tablet computer to open the spreadsheet.

Additionally, in some embodiments, a single device may re-create the state of the missing device using various applications provided by the single device. For example, consider again the scenario where the cell phone may open the spreadsheet on a viewing application that may not have editing capabilities. Instead of using the spreadsheet viewing application, the cell phone may copy data from the spreadsheet and provide the data in a word processing application to allow for editing. Further, in some examples, the cell phone may provide a menu of various applications to choose from such that the spreadsheet can be viewed and/or modified by the particular application chosen.

In a further aspect, when modifying a device-group snapshot in an effort to account for missing devices, a hub system may determine that the state for a single missing device may be replicated and transferred to two or more devices in the target device group. Yet further, a hub system may determine that the state for a single device may be separated into portions such that each portion may be independently transferred to other devices. For instance, in FIG. 1B, device state 122b may be an audiovisual record (provided by television receiver 114b) including an audio portion and a visual portion. In some instances, the audio portion of device state 122b may be transferred to wearable computer 102b, whereas the visual portion may be transferred to tablet computer 110b.

In addition, consider the scenario above for the above example in practice such that a source device group includes a television with a display monitor with no audio capabilities. Yet further, when the television is missing from the target device group, the device-group snapshot may be modified such that the audio portion is played on a smartphone and the video portion is played on the display monitor.

It should be understood that the examples provided for modifying the device-group snapshot are for illustrative purposes and are not meant to be limiting. There may be other possibilities without departing from the scope of the embodiments herein

b. Modifications to Help Take Advantage of Additional Devices

As noted, the target device group and source device group may differ because the target device group may include additional devices, which were not included in the source device group. In some instances, it may be determined that these additional devices may be more appropriate to load some or all of the stored device states taken from the source device group. Further, in some instances, these additional devices may load the device states regardless of whether the source devices are still available to be included the target device group.

In some cases, when modifying the device-group snapshot, a device from the source device group may be missing. Further, in some cases, no devices from the source device group may be included in the target device group. In such instances, there may be a preference for transferring and/or re-creating the device state (or a portion of the device state) from the missing device onto an additional device in the target device group. More specifically, such a preference may be established by initially determining whether the additional device is appropriate for restoring a device state for the missing device. Then, in addition, a weighting process may be applied (e.g., based on device priority and/or a device hierarchy) to consider which device in the target device group would be best suited to restore the device state (or a portion thereof). Further, the weighting process may favor (i.e. increase weight for) newly available devices due to various factors (e.g., higher battery levels, data throughput, network connectivity, etc.).

Further, in some embodiments, there may be no preference for modifying or recreating the device state for an additional device in the target device group. For example, the above-described weighting process may be applied without increasing weight for newly available devices. Other examples are possible as well.

It should be understood that the above examples including additional devices are provided for purposes of illustration and that other possibilities may also exist without departing from the scope of the embodiments herein.

c. Modifications Based on Context

In a further aspect, a device-group snapshot may be modified for a target device group based on context. For instance, a device-group snapshot may be created for a television set showing a baseball game (including both an audio and a visual portion). At a later period in time, a user may be driving a car and an instruction may be provided to restore the device-group snapshot. For this scenario, consider that the car's computer system is provided as an available device in the target device group and further, consider that the car determines a context (from the car's acceleration, velocity, and/or inertial movement) indicative of the user driving the car.

Therefore, based on the instruction to restore the device-group snapshot and the current context of the user driving the car, the device-group snapshot may be modified such that only the audio portion of the baseball game may be provided through the car's speaker system (without providing the visual portion which may be capable of being displayed on the car's in-vehicle television sets).

In another example, which may be demonstrated using FIG. 1B, the modification of the device-group snapshot may be based on one or more context signals. For instance, a device-group snapshot may be created for television receiver 114b and its television set showing a baseball game (including both an audio and a visual portion). Further, wearable computer 102b may determine a context such that the devices in the target device group are in a setting (e.g., public library, classroom, and/or office building) where the audio portion of device state 122b should not be played out loud.

In such instances, the device-group snapshot may be modified such that the audio portion of device state 122b may be transferred from television receiver 114b in the source device group to wearable computer 102b in the target device group (e.g., played through head phones or ear buds incorporated in wearable computer 102b.) In this respect, others proximate to the devices in the target device group will not be disturbed. Further, in some instances, the visual portion of device state 122b may be played on tablet computer 110.

In some instances, which may further be illustrated in FIG. 1B, television receiver 114b may not only be in the source device group, but it may also be in the target device group. In such instances, television receiver 114b (in the target device group) may play the visual portion of device state 122b and transfer the audio portion of device state 122b to wearable computer 102b. Further, the visual portion of device state 122b may also be transferred (i.e. replicated) to tablet computer 110b to see the audio portion from various sources.

It should be understood that the above examples based on context are provided for purposes of illustration and that other possibilities may also exist without departing from the scope of the embodiments herein.

d. Exemplary Types of Modifications

In many cases, applications in the source device group used to create the device-group snapshot may differ from the applications in the target device group available to the load the device-group snapshot. Therefore, a device-group snapshot may be modified based on the applications available in the target device group to load the device-group snapshot.

For example, a personal computer may store a word-processing document (possibly in Microsoft® Word format) to a device-group snapshot. However, a mobile handset in the target device group may not have the same word-processing application and instead, may have a different application for viewing documents (such as Adobe Portable Document Format (PDF) format). To restore the document to the mobile handset, the word-processing document file type may be converted (from Microsoft® Word format to PDF format) during modification of the device-group snapshot to upload the document to the mobile handset.

To provide another example, a word-processing document with both photographs and text may be open on a laptop computer. In this example, consider that a device-group snapshot is created including the word-processing document with both the photographs and the text. However, the device-group snapshot may be loaded on a smartphone with limited functionality (e.g., the smartphone has limited RAM space for uploading the photographs). In such instances, only the text may be restored on the smartphone and the photographs may be omitted. However, in some instances, the photographs may be uploaded onto a tablet computer that is in proximity to the smartphone and is capable of restoring the photos.

In some embodiments, a device-group snapshot may modify the media type of a device state based on a context and/or a change in context. For example, consider a device-group snapshot created for a television set playing a baseball game on a specific TV channel. The device-group snapshot may be modified such that when the user is in a car and the snapshot is restored, the car may not play the baseball game on the in-vehicle television set. Rather, the car may locate and play the radio broadcasting of game through the car stereo system.

In another example, a device-group snapshot may be taken of an electronic book reader and the snapshot may be modified for a context when the user is driving a car. While the user drives the car, the snapshot may be modified to a “books on tape” audio recording which may be played through the car stereo. Further, in some instances, the “books on tape” audio recording may resume from the same page location shown of the electronic book reader when the device-group snapshot was taken.

It should be understood that the above examples for modifying the device-group snapshot are provided for illustrative purposes and are not meant to be limiting. Further, there may be other possible ways for modifying a device-group snapshot without departing from the scope of the embodiments herein.

v. Communicating with the Target Device Group to Load the Modified Device-Group Snapshot

As noted, “loading” or “restoring” a device-group snapshot should be understood to involve a hub system sending instructions to one or more devices in the target device group to restore or load respective states as indicated by the device-group snapshot. In some instances, restoring and/or loading may involve an “approximation” resulting in a partial restoration of the device-group snapshot. More specifically, in some instances, certain portions of device states captured from device-group snapshot are loaded to the devices in the target device group, however, not all portions may be restored.

As described, the embodiments above are provided for purposes of illustration and should not be taken as limiting. Other possibilities for loading the modified device-group snapshot may also exist without departing from the scope of the embodiments herein.

vi. Utilizing Context

Further, the hub system may determine various other types of context based on context signals and restore a device-group snapshot accordingly. For example, context signals may include: (a) the current time, (b) the current date, (c) the current day of the week, (d) the current month, (e) the current season, (f) a time of a future event or future user-context, (g) a date of a future event or future user-context, (h) a day of the week of a future event or future context, (i) a month of a future event or future user-context, (j) a season of a future event or future user-context, (k) a time of a past event or past user-context, (l) a date of a past event or past user-context, (m) a day of the week of a past event or past user-context, (n) a month of a past event or past user-context, (o) a season of a past event or past user-context, ambient temperature near the user (or near a hub system associated with a user), (p) a current, future, and/or past weather forecast at or near a user's current location, (q) a current, future, and/or past weather forecast at or near a location of a planned event in which a user and/or a user's friends plan to participate, (r) a current, future, and/or past weather forecast at or near a location of a previous event in which a user and/or a user's friends participated, (s) information on user's calendar, such as information regarding events or statuses of a user or a user's friends, (t) information accessible via a user's social networking account, such as information relating a user's status, statuses of a user's friends in a social network group, and/or communications between the user and the users friends, (u) noise level or any recognizable sounds detected by a hub system, (v) devices that are currently available to a hub system (perhaps to load a device-group snapshot), (w) devices that have been detected by a hub system (possibly detected by proximity to the hub system), (x) devices associated with a hub system (e.g., devices that are “trusted” by the hub system, devices associated with the user's account, etc.), (y) information derived from cross-referencing any two or more of: information on a user's calendar, information available via a user's social networking account, and/or other context signals or sources of context information, (z) health statistics or characterizations of a user's current health (e.g., whether a user has a fever or whether a user just woke up from being asleep), and (aa) a user's recent context as determined from sensors on or near the user and/or other sources of context information, (bb) a current location, (cc) a past location, and (dd) a future location.

In one embodiment, a hub system such as a wearable computer may receive context signals related to the weather to determine when to restore a device-group snapshot. For example, a web browser providing updated information regarding the weather may be stored to a device-group snapshot. Upon determining (through additional context signals) that a user with the wearable computer is getting ready to go outside, the wearable computer may upload the web browser providing (through the wearable computer) updated information regarding the weather. Therefore, if it is raining, then the user will be informed ahead of time and can prepare for the weather before leaving (e.g., by getting an umbrella).

It should be understood that the above examples of context and context signals are provided for illustration and that other possibilities may exist without departing from the scope of the embodiments herein.

### E. Example System and Device Architecture

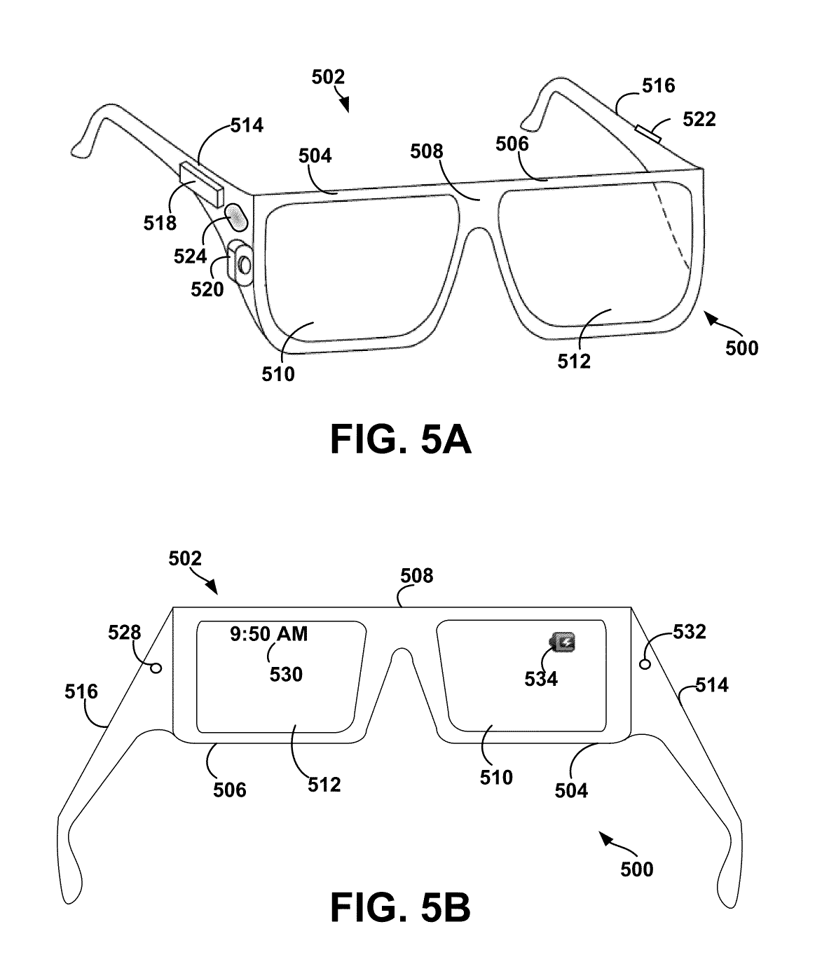

FIG. 5A is a diagram illustrating a first example system for receiving, transmitting, and displaying data, according to an exemplary embodiment. The system 500 is shown in the form of a wearable computing device. While FIG. 5A illustrates a head-mounted device 502 as an example of a wearable computing device, other types of wearable computing devices could additionally or alternatively be used. As illustrated in FIG. 5A, the head-mounted device 502 has frame elements including lens-frames 504, 506 and a center frame support 508, lens elements 510, 512, and extending side-arms 514, 516. The center frame support 508 and the extending side-arms 514, 516 are configured to secure the head-mounted device 502 to a user's face via a user's nose and ears, respectively.

Each of the frame elements 504, 506, and 508 and the extending side-arms 514, 516 may be formed of a solid structure of plastic and/or metal, or may be formed of a hollow structure of similar material so as to allow wiring and component interconnects to be internally routed through the head-mounted device 502. Other materials may be possible as well.

One or more of each of the lens elements 510, 512 may be formed of any material that can suitably display a projected image or graphic. Each of the lens elements 510, 512 may also be sufficiently transparent to allow a user to see through the lens element. Combining these two features of the lens elements may facilitate an augmented reality or heads-up display where the projected image or graphic is superimposed over a real-world view as perceived by the user through the lens elements 510, 512.

The extending side-arms 514, 516 may each be projections that extend away from the lens-frames 504, 506, respectively, and may be positioned behind a user's ears to secure the head-mounted device 502 to the user. The extending side-arms 514, 516 may further secure the head-mounted device 502 to the user by extending around a rear portion of the user's head. Additionally or alternatively, for example, the system 500 may connect to or be affixed within a head-mounted helmet structure. Other possibilities exist as well.

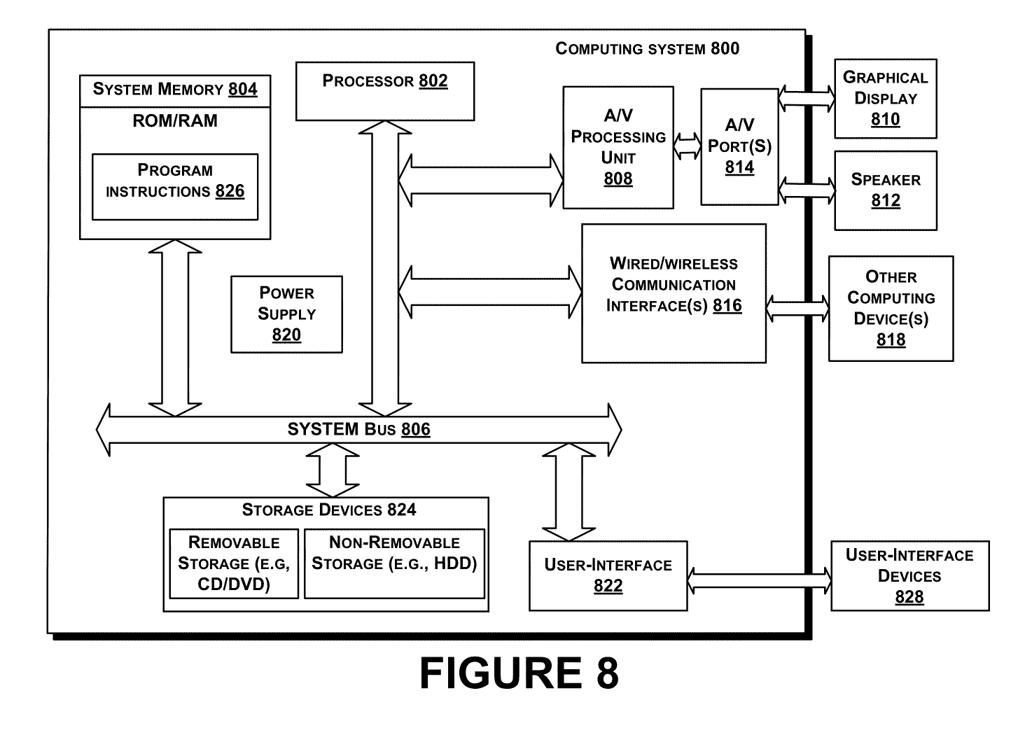

The system 500 may also include an on-board computing system 518, a video camera 520, a sensor 522, and a finger-operable touch pad 524. The on-board computing system 518 is shown to be positioned on the extending side-arm 514 of the head-mounted device 502; however, the on-board computing system 518 may be provided on other parts of the head-mounted device 502 or may be positioned remote from the head-mounted device 502 (e.g., the on-board computing system 518 could be connected by wires or wirelessly connected to the head-mounted device 502). The on-board computing system 518 may include a processor and memory, for example. The on-board computing system 518 may be configured to receive and analyze data from the video camera 520, the sensor 522, and the finger-operable touch pad 524 (and possibly from other sensory devices, user-interfaces, or both) and generate images for output by the lens elements 510 and 512. The on-board computing system 518 may additionally include a speaker or a microphone for user input (not shown). An example computing system is further described below in connection with FIG. 8.

The video camera 520 is shown positioned on the extending side-arm 514 of the head-mounted device 502; however, the video camera 520 may be provided on other parts of the head-mounted device 502. The video camera 520 may be configured to capture images at various resolutions or at different frame rates. Video cameras with a small form-factor, such as those used in cell phones or webcams, for example, may be incorporated into an example embodiment of the system 500.

Further, although FIG. 5A illustrates one video camera 520, more video cameras may be used, and each may be configured to capture the same view, or to capture different views. For example, the video camera 520 may be forward facing to capture at least a portion of the real-world view perceived by the user. This forward facing image captured by the video camera 520 may then be used to generate an augmented reality where computer generated images appear to interact with the real-world view perceived by the user.

The sensor 522 is shown on the extending side-arm 516 of the head-mounted device 502; however, the sensor 522 may be positioned on other parts of the head-mounted device 502. The sensor 522 may include one or more of a gyroscope or an accelerometer, for example. Other sensing devices may be included within, or in addition to, the sensor 522 or other sensing functions may be performed by the sensor 522.

The finger-operable touch pad 524 is shown on the extending side-arm 514 of the head-mounted device 502. However, the finger-operable touch pad 524 may be positioned on other parts of the head-mounted device 502. Also, more than one finger-operable touch pad may be present on the head-mounted device 502. The finger-operable touch pad 524 may be used by a user to input commands. The finger-operable touch pad 524 may sense at least one of a position and a movement of a finger via capacitive sensing, resistance sensing, or a surface acoustic wave process, among other possibilities. The finger-operable touch pad 524 may be capable of sensing finger movement in a direction parallel or planar to the pad surface, in a direction normal to the pad surface, or both, and may also be capable of sensing a level of pressure applied to the pad surface. The finger-operable touch pad 524 may be formed of one or more translucent or transparent insulating layers and one or more translucent or transparent conducting layers. Edges of the finger-operable touch pad 524 may be formed to have a raised, indented, or roughened surface, so as to provide tactile feedback to a user when the user's finger reaches the edge, or other area, of the finger-operable touch pad 524. If more than one finger-operable touch pad is present, each finger-operable touch pad may be operated independently, and may provide a different function.

FIG. 5B is a diagram illustrating an alternate view of the system illustrated in FIG. 5A, according to an exemplary embodiment. As shown in FIG. 5B, the lens elements 510, 512 may act as display elements. The head-mounted device 502 may include a first projector 528 coupled to an inside surface of the extending side-arm 516 and configured to project a display 530 onto an inside surface of the lens element 512. Additionally or alternatively, a second projector 532 may be coupled to an inside surface of the extending side-arm 514 and configured to project a display 534 onto an inside surface of the lens element 510.

The lens elements 510, 512 may act as a combiner in a light projection system and may include a coating that reflects the light projected onto them from the projectors 528, 532. In some embodiments, a reflective coating may be omitted (e.g., when the projectors 528, 532 are scanning laser devices).

In alternative embodiments, other types of display elements may also be used. For example, the lens elements 510, 512 themselves may include: a transparent or semi-transparent matrix display, such as an electroluminescent display or a liquid crystal display, one or more waveguides for delivering an image to the user's eyes, or other optical elements capable of delivering an in focus near-to-eye image to the user. A corresponding display driver may be disposed within the frame elements 504, 506 for driving such a matrix display. Alternatively or additionally, a laser or light emitting diode (LED) source and scanning system could be used to draw a raster display directly onto the retina of one or more of the user's eyes. Other possibilities exist as well.

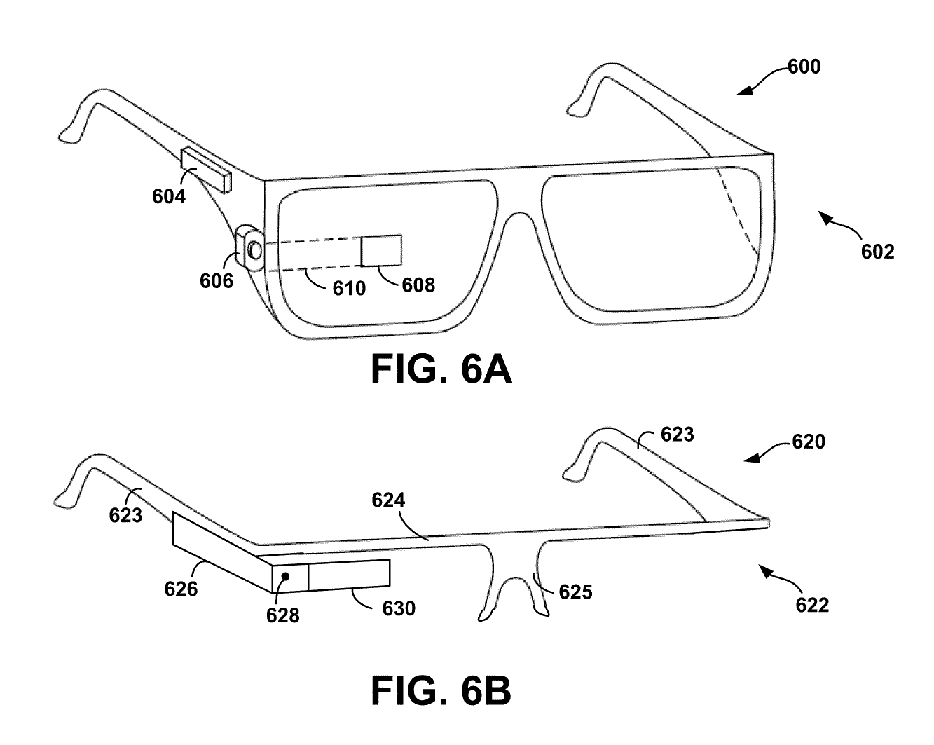

FIG. 6A is a diagram illustrating a second example system for receiving, transmitting, and displaying data, according to an exemplary embodiment. The system 600 is shown in the form of a wearable computing device 602. The wearable computing device 602 may include frame elements and side-arms such as those described with respect to FIGS. 5A and 5B. The wearable computing device 602 may additionally include an on-board computing system 604 and a video camera 606, such as those described with respect to FIGS. 5A and 5B. The video camera 606 is shown mounted on a frame of the wearable computing device 602; however, the video camera 606 may be mounted at other positions as well.

As shown in FIG. 6A, the wearable computing device 602 may include a single display 608 which may be coupled to the device. The display 608 may be formed on one of the lens elements of the wearable computing device 602, such as a lens element described with respect to FIGS. 5A and 5B, and may be configured to overlay computer-generated graphics in the user's view of the physical world. The display 608 is shown to be provided in a center of a lens of the wearable computing device 602, however, the display 608 may be provided in other positions. The display 608 is controllable via the computing system 604 that is coupled to the display 608 via an optical waveguide 610.

FIG. 6B is a diagram illustrating a third example system for receiving, transmitting, and displaying data, according to an exemplary embodiment. The system 620 is shown in the form of a wearable computing device 622. The wearable computing device 622 may include side-arms 623, a center frame support 624, and a bridge portion with nosepiece 625. In the example shown in FIG. 6B, the center frame support 624 connects the side-arms 623. The wearable computing device 622 does not include lens-frames containing lens elements. The wearable computing device 622 may additionally include an on-board computing system 626 and a video camera 628, such as those described with respect to FIGS. 5A and 5B.

The wearable computing device 622 may include a single lens element 630 that may be coupled to one of the side-arms 623 or the center frame support 624. The lens element 630 may include a display such as the display described with reference to FIGS. 5A and 5B, and may be configured to overlay computer-generated graphics upon the user's view of the physical world. In one example, the single lens element 630 may be coupled to a side of the extending side-arm 623. The single lens element 630 may be positioned in front of or proximate to a user's eye when the wearable computing device 622 is worn by a user. For example, the single lens element 630 may be positioned below the center frame support 624, as shown in FIG. 6B.

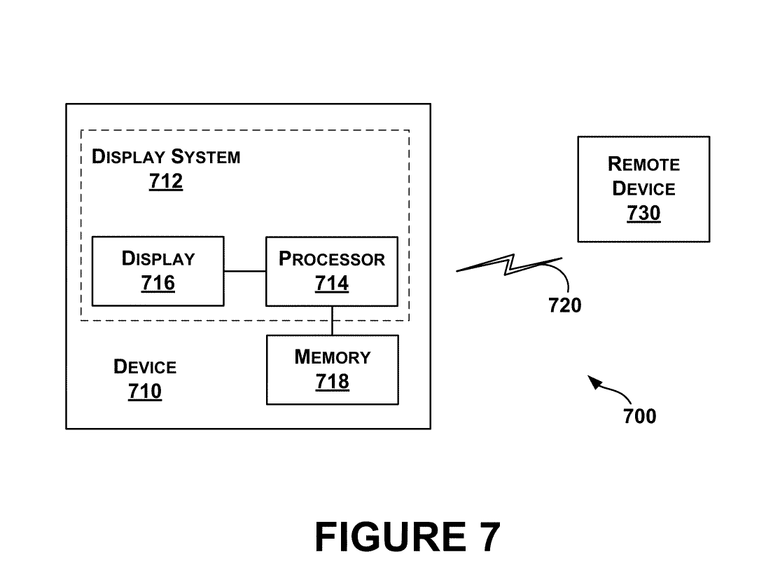

FIG. 7 is a simplified block diagram illustrating an example computer network infrastructure, according to an exemplary embodiment. In system 700, a device 710 communicates using a communication link 720 (e.g., a wired or wireless connection) to a remote device 730. The device 710 may be any type of device that can receive data and display information corresponding to or associated with the data. For example, the device 710 may be a heads-up display system, such as the head-mounted device 502, 600, or 620 described with reference to FIGS. 5A-6B.

Thus, the device 710 may include a display system 712 comprising a processor 714 and a display 716. The display 716 may be, for example, an optical see-through display, an optical see-around display, or a video see-through display. The processor 714 may receive data from the remote device 730, and configure the data for display on the display 716. The processor 714 may be any type of processor, such as a micro-processor or a digital signal processor, for example.

The device 710 may further include on-board data storage, such as memory 718 coupled to the processor 714. The memory 718 may store software that can be accessed and executed by the processor 714, for example.

The remote device 730 may be any type of computing device or transmitter including a laptop computer, a mobile telephone, or tablet computing device, etc., that is configured to transmit data to the device 710. The remote device 730 and the device 710 may contain hardware to enable the communication link 720, such as processors, transmitters, receivers, antennas, etc.

In FIG. 7, the communication link 720 is illustrated as a wireless connection; however, wired connections may also be used. For example, the communication link 720 may be a wired serial bus such as a universal serial bus or a parallel bus, among other connections. The communication link 720 may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), and/or Zigbee, among other possibilities. Either of such a wired and/or wireless connection may be a proprietary connection as well. The remote device 730 may be accessible via the Internet and may include a computing cluster associated with a particular web service (e.g., social-networking, photo sharing, address book, etc.).

As described above in connection with FIGS. 5A-6B, an example wearable computing device may include, or may otherwise be communicatively coupled to, a computing system, such as computing system 518 or computing system 604. FIG. 8 is a simplified block diagram illustrating example components of an example computing system, according to an exemplary embodiment. One or both of the device 710 and the remote device 730 may take the form of computing system 800.

Computing system 800 may include at least one processor 802 and system memory 804. In an example embodiment, computing system 800 may include a system bus 806 that communicatively connects processor 802 and system memory 804, as well as other components of computing system 800. Depending on the desired configuration, processor 802 can be any type of processor including, but not limited to, a microprocessor (μP), a microcontroller (μC), a digital signal processor (DSP), or any combination thereof. Furthermore, system memory 804 can be of any type of memory now known or later developed including but not limited to volatile memory (such as RAM), non-volatile memory (such as ROM, flash memory, etc.) or any combination thereof

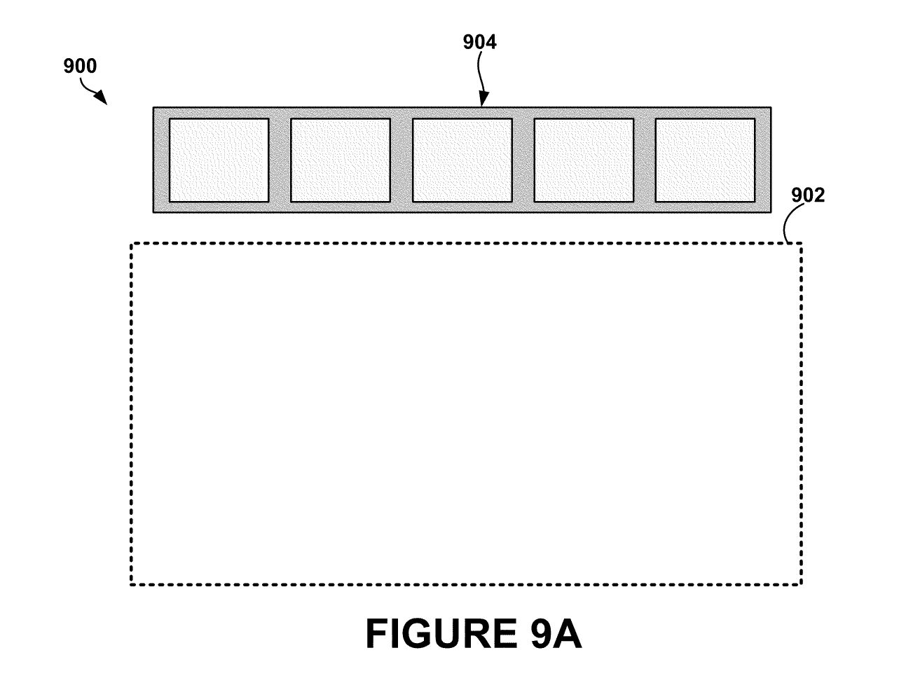

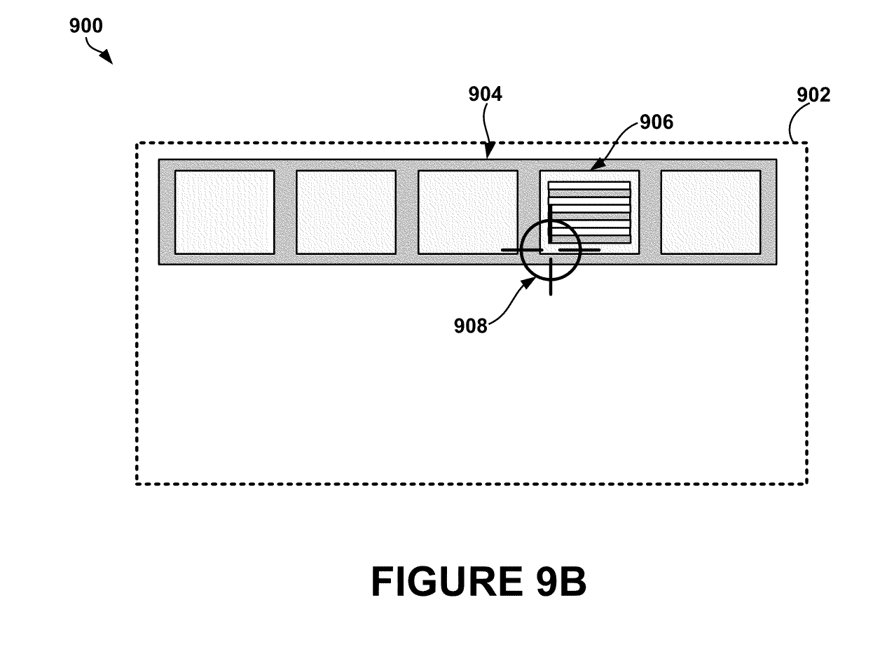

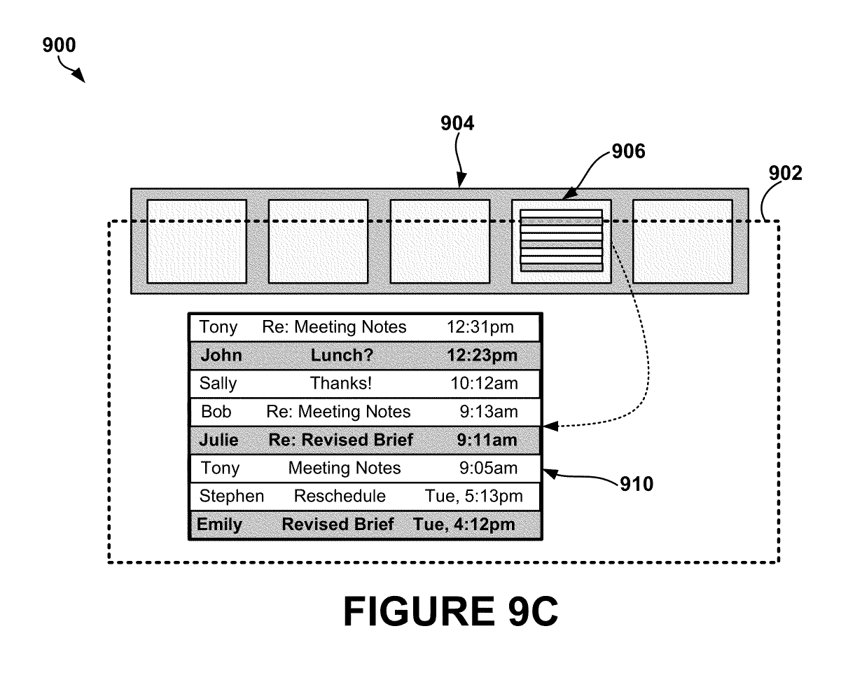

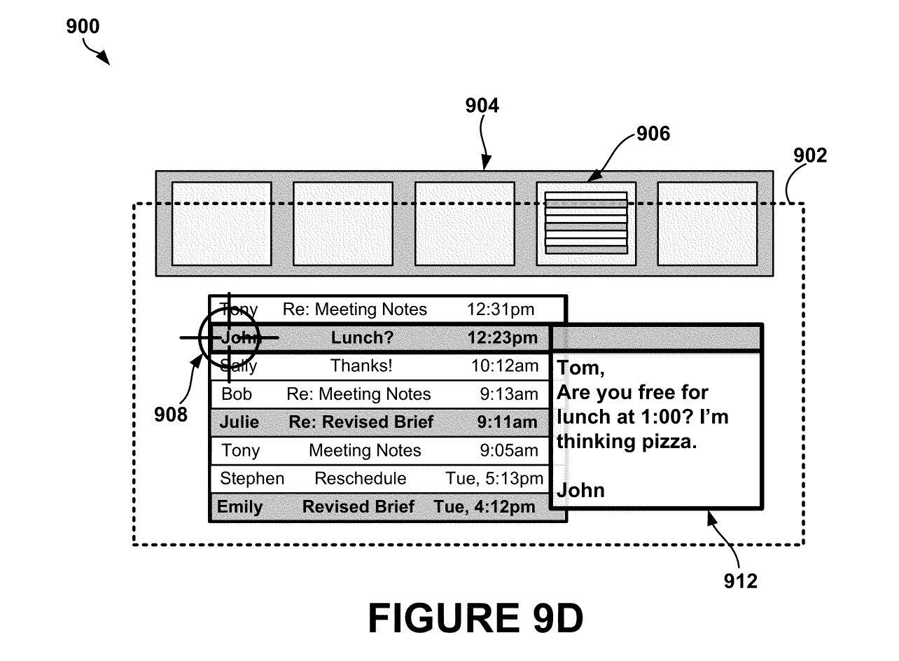

An example computing system 800 may include various other components as well. For example, computing system 800 includes an A/V processing unit 808 for controlling graphical display 810 and speaker 812 (via A/V port 814), one or more communication interfaces 816 for connecting to other computing devices 818, and a power supply 820. Graphical display 810 may be arranged to provide a visual depiction of various input regions provided by user-interface module 822. For example, user-interface module 822 may be configured to provide a user-interface, such as the example user-interface described below in connection with other FIGS. 9A-D below and graphical display 810 may be configured to provide a visual depiction of the user-interface.

FIG. 9A is a diagram illustrating aspects of an example user-interface, according to an exemplary embodiment. FIG. 9B is a diagram illustrating aspects of an example user-interface after receiving movement data corresponding to an upward movement, according to an exemplary embodiment. FIG. 9C is a diagram illustrating aspects of an example user-interface after selection of a selected content object, according to an exemplary embodiment. FIG. 9D is a diagram illustrating aspects of an example user-interface after receiving input data corresponding to a user input, according to an exemplary embodiment.

User-interface module 822 may be further configured to receive data from and transmit data to (or be otherwise compatible with) one or more user-interface devices 828.

Furthermore, computing system 800 may also include one or more data storage devices 824, which can be removable storage devices, non-removable storage devices, or a combination thereof. Examples of removable storage devices and non-removable storage devices include magnetic disk devices such as flexible disk drives and hard-disk drives (HDD), optical disk drives such as compact disk (CD) drives or digital versatile disk (DVD) drives, solid state drives (SSD), and/or any other storage device now known or later developed. Computer storage media can include volatile and nonvolatile, removable and non-removable media implemented in any method or technology for storage of information, such as computer readable instructions, data structures, program modules, or other data. For example, computer storage media may take the form of RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium now known or later developed that can be used to store the desired information and which can be accessed by computing system 800.

According to an example embodiment, computing system 800 may include program instructions 826 that are stored in system memory 804 (and/or possibly in another data-storage medium) and executable by processor 802 to facilitate the various functions described herein including, but not limited to, those functions described with respect to [METHOD FIGURES]. Although various components of computing system 800 are shown as distributed components, it should be understood that any of such components may be physically integrated and/or distributed according to the desired configuration of the computing system.

### E. Example User-Interface

FIGS. 9A-D show aspects of an example user-interface 900. The user-interface 900 may be displayed by, for example, a wearable computing device as described above for FIGS. 5A-6B.

An example state of the user-interface 900 is shown in FIG. 9A. The example state shown in FIG. 9A may correspond to a first position of the wearable computing device. That is, the user-interface 900 may be displayed as shown in FIG. 9A when the wearable computing device is in the first position. In some embodiments, the first position of the wearable computing device may correspond to a position of the wearable computing device when a wearer of the wearable computing device is looking in a direction that is generally parallel to the ground (e.g., a position that does not correspond to the wearer looking up or looking down). Other examples are possible as well.

As shown, the user-interface 900 includes a view region 902. An example boundary of the view region 902 is shown by a dotted frame. While the view region 902 is shown to have a landscape shape (in which the view region 902 is wider than it is tall), in other embodiments the view region 902 may have a portrait or square shape, or may have a non-rectangular shape, such as a circular or elliptical shape. The view region 902 may have other shapes as well.

The view region 902 may be, for example, the viewable area between (or encompassing) the upper, lower, left, and right boundaries of a display on the wearable computing device. As shown, when the wearable computing device is in the first position, the view region 902 is substantially empty (e.g., completely empty) of user-interface elements, such that the user's view of their real-world environment is generally uncluttered, and objects in the user's environment are not obscured.

In some embodiments, the view region 902 may correspond to a field of view of a wearer of the wearable computing device, and an area outside the view region 902 may correspond to an area outside the field of view of the wearer. In other embodiments, the view region 902 may correspond to a non-diagonal portion of a field of view of a wearer of the wearable computing device, and an area outside the view region 902 may correspond to a diagonal portion of the field of view of the wearer. In still other embodiments, the user-interface 900 may be larger than or substantially the same as a field of view of a wearer of the wearable computing device, and the field of view of the wearer may be larger than or substantially the same size as the view region 902. The view region 902 may take other forms as well.

Accordingly, the portions of the user-interface 900 outside of the view region 902 may be outside of or in a diagonal portion of a field of view of a wearer of the wearable computing device. For example, as shown, a menu 904 may be outside of or in a diagonal portion of the field of view of the user in the user-interface 900. While the menu 904 is shown to be not visible in the view region 902, in some embodiments the menu 904 may be partially visible in the view region 902.

In some embodiments, the wearable computing device may be configured to receive movement data corresponding to, for example, an upward movement of the wearable computing device to a position above the first position. In these embodiments, the wearable computing device may, in response to receiving the movement data corresponding to the upward movement, cause one or both of the view region 902 and the menu 904 to move such that the menu 904 becomes more visible in the view region 902. For example, the wearable computing device may cause the view region 902 to move upward and may cause the menu 904 to move downward. The view region 902 and the menu 904 may move the same amount, or may move different amounts. In one embodiment, the menu 904 may move further than the view region 902. As another example, the wearable computing device may cause only the menu 904 to move. Other examples are possible as well.

While the term “upward” is used, it is to be understood that the upward movement may encompass any movement having any combination of moving, tilting, rotating, shifting, sliding, or other movement that results in a generally upward movement. Further, in some embodiments “upward” may refer to an upward movement in the reference frame of a wearer of the wearable computing device. Other reference frames are possible as well. In embodiments where the wearable computing device is a head-mounted device, the upward movement of the wearable computing device may also be an upward movement of a wearer's head such as, for example, the user looking upward.

The movement data corresponding to the upward movement may take several forms. For example, the movement data may be (or may be derived from) data received from one or more movement sensors, accelerometers, and/or gyroscopes configured to detect the upward movement, such as the sensor 922 described above in connection with FIG. 9A. In some embodiments, the movement data may comprise a binary indication corresponding to the upward movement. In other embodiments, the movement data may comprise an indication corresponding to the upward movement as well as an extent of the upward movement. The movement data may take other forms as well.

FIG. 9B shows aspects of an example user-interface after receiving movement data corresponding to an upward movement. As shown, the user-interface 900 includes the view region 902 and the menu 904.

As noted above, in response to receiving the movement data corresponding to an upward movement of the wearable computing device, the wearable computing device may move one or both of the view region 902 and the menu 904 such that the menu 904 becomes more visible in the view region 902.

As shown, the menu 904 is fully visible in the view region 902. In other embodiments, however, only a portion of the menu 904 may be visible in the view region 902. In some embodiments, the extent to which the menu 904 is visible in the view region 902 may be based at least in part on an extent of the upward movement.

Thus, the view region 902 may be moved in response to receiving data corresponding to an upward movement. In some embodiments, the view region 902 may be moved in an upward scrolling or panning motion. For instance, the view region 902 may appear to a wearer of the wearable computing device as if mapped onto the inside of a static sphere centered at the wearable computing device, and movement of the view region 902 may map onto movement of the real-world environment relative to the wearable computing device. A speed, acceleration, and/or magnitude of the upward scrolling may be based at least in part on a speed, acceleration, and/or magnitude of the upward movement. In other embodiments, the view region 902 may be moved by, for example, jumping between fields of view. In still other embodiments, the view region 902 may be moved only when the upward movement exceeds a threshold speed, acceleration, and/or magnitude. In response to receiving data corresponding to an upward movement that exceeds such a threshold or thresholds, the view region 902 may pan, scroll, slide, or jump to a new field of view. The view region 902 may be moved in other manners as well.

While the foregoing description focused on upward movement, it is to be understood that the wearable computing device could be configured to receive data corresponding to other directional movement (e.g., downward, leftward, rightward, etc.) as well, and that the view region 902 may be moved in response to receiving such data in a manner similar to that described above in connection with upward movement.

As shown, the menu 904 includes a number of content objects 906. In some embodiments, the content objects 906 may be arranged in a ring (or partial ring) around and above the head of a wearer of the wearable computing device. In other embodiments, the content objects 906 may be arranged in a dome-shape above the wearer's head. The ring or dome may be centered above the wearable computing device and/or the wearer's head. In other embodiments, the content objects 906 may be arranged in other ways as well.

The number of content objects 906 in the menu 904 may be fixed or may be variable. In embodiments where the number is variable, the content objects 906 may vary in size according to the number of content objects 906 in the menu 904. In embodiments where the content objects 906 extend circularly around a wearer's head, like a ring (or partial ring), only some of the content objects 906 may be visible at a particular moment. In order to view other content objects 904, a wearer of the wearable computing device may interact with the wearable computing device to, for example, rotate the content objects 906 along a path (e.g., clockwise or counterclockwise) around the wearer's head. To this end, the wearable computing device may be configured to receive data indicating such an interaction through, for example, a touch pad, such as finger-operable touch pad 924. Alternatively or additionally, the wearable computing device may be configured to receive such data through other input devices as well.

Depending on the application of the wearable computing device, the content objects 906 may take several forms. For example, the content objects 906 may include one or more of people, contacts, groups of people and/or contacts, calendar items, lists, notifications, alarms, reminders, status updates, incoming messages, recorded media, audio recordings, video recordings, photographs, digital collages, previously-saved states, webpages, and applications, as well as tools, such as a still camera, a video camera, and an audio recorder. Content objects 906 may take other forms as well.

In embodiments where the content objects 906 include tools, the tools may be located in a particular region of the menu 904, such as the center. In some embodiments, the tools may remain in the center of the menu 904, even if the other content objects 906 rotate, as described above. Tool content objects may be located in other regions of the menu 904 as well.

The particular content objects 906 that are included in menu 904 may be fixed or variable. For example, the content objects 906 may be preselected by a wearer of the wearable computing device. In another embodiment, the content objects 906 for each content region may be automatically assembled by the wearable computing device from one or more physical or digital contexts including, for example, people, places, and/or objects surrounding the wearable computing device, address books, calendars, social-networking web services or applications, photo sharing web services or applications, search histories, and/or other contexts. Further, some content objects 906 may fixed, while the content objects 906 may be variable. The content objects 906 may be selected in other manners as well.

Similarly, an order or configuration in which the content objects 906 are displayed may be fixed or variable. In one embodiment, the content objects 906 may be pre-ordered by a wearer of the wearable computing device. In another embodiment, the content objects 906 may be automatically ordered based on, for example, how often each content object 906 is used (on the wearable computing device only or in other contexts as well), how recently each content object 906 was used (on the wearable computing device only or in other contexts as well), an explicit or implicit importance or priority ranking of the content objects 906, and/or other criteria.

In some embodiments, the wearable computing device may be further configured to receive from the wearer a selection of a content object 906 from the menu 904. To this end, the user-interface 900 may include a cursor 908, shown in FIG. 9B as a reticle, which may be used to navigate to and select content objects 906 from the menu 904. In some embodiments, the cursor 908 may be controlled by a wearer of the wearable computing device through one or more predetermined movements. Accordingly, the wearable computing device may be further configured to receive selection data corresponding to the one or more predetermined movements.

The selection data may take several forms. For example, the selection data may be (or may be derived from) data received from one or more movement sensors, accelerometers, gyroscopes, and/or detectors configured to detect the one or more predetermined movements. The one or more movement sensors may be included in the wearable computing device, like the sensor 922, or may be included in a diagonal device communicatively coupled to the wearable computing device. As another example, the selection data may be (or may be derived from) data received from a touch pad, such as the finger-operable touch pad 924 described above in connection with FIG. 9A, or other input device included in or coupled to the wearable computing device and configured to detect one or more predetermined movements. In some embodiments, the selection data may take the form of a binary indication corresponding to the predetermined movement. In other embodiments, the selection data may indicate the extent, the direction, the velocity, and/or the acceleration associated with the predetermined movement. The selection data may take other forms as well.

The predetermined movements may take several forms. In some embodiments, the predetermined movements may be certain movements or sequence of movements of the wearable computing device or diagonal device. In some embodiments, the predetermined movements may include one or more predetermined movements defined as no or substantially no movement, such as no or substantially no movement for a predetermined period of time. In embodiments where the wearable computing device is a head-mounted device, one or more predetermined movements may involve a predetermined movement of the wearer's head (which is assumed to move the wearable computing device in a corresponding manner). Alternatively or additionally, the predetermined movements may involve a predetermined movement of a diagonal device communicatively coupled to the wearable computing device. The diagonal device may similarly be wearable by a wearer of the wearable computing device, such that the movement of the diagonal device may follow a movement of the wearer, such as, for example, a movement of the wearer's hand. Still alternatively or additionally, one or more predetermined movements may be, for example, a movement across a finger-operable touch pad or other input device. Other predetermined movements are possible as well.

As shown, a wearer of the wearable computing device has navigated the cursor 908 to the content object 906 using one or more predetermined movements. In order to select the content object 906, the wearer may perform an additional predetermined movement, such as holding the cursor 908 over the content object 906 for a predetermined period of time. The wearer may select the content object 906 in other manners as well.

Once a content object 906 is selected, the wearable computing device may cause the content object 906 to be displayed in the view region 902 as a selected content object. FIG. 9C shows aspects of an example user-interface after selection of a selected content object, in accordance with an embodiment.

As indicated by the dotted arrow, the content object 906 is displayed in the view region 902 as a selected content object 910. As shown, the selected content object 910 is displayed larger and in more detail in the view region 902 than in the menu 904. In other embodiments, however, the selected content object 910 could be displayed in the view region 902 smaller than or the same size as, and in less detail than or the same detail as, the menu 904. In some embodiments, additional content (e.g., actions to be applied to, with, or based on the selected content object 910, information related to the selected content object 910, and/or modifiable options, preferences, or parameters for the selected content object 910, etc.) may be showed adjacent to or nearby the selected content object 910 in the view region 902.

Once the selected content object 910 is displayed in the view region 902, a wearer of the wearable computing device may interact with the selected content object 910. For example, as the selected content object 910 is shown as an email inbox, the wearer may wish to read one of the emails in the email inbox. Depending on the selected content object, the wearer may interact with the selected content object in other ways as well (e.g., the wearer may locate additional information related to the selected content object 910, modify, augment, and/or delete the selected content object 910, etc.). To this end, the wearable computing device may be further configured to receive input data corresponding to one or more predetermined movements indicating interactions with the user-interface 900. The input data may take any of the forms described above in connection with the selection data.

FIG. 9D shows aspects of an example user-interface after receiving input data corresponding to a user input, in accordance with an embodiment. As shown, a wearer of the wearable computing device has navigated the cursor 908 to a particular subject line in the email inbox and selected the subject line. As a result, the email 912 is displayed in the view region, so that the wearer may read the email 912. The wearer may interact with the user-interface 900 in other manners as well, depending on, for example, the selected content object.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

I claim:

1. A computer-implemented method comprising:
receiving an instruction to load a device-group snapshot, wherein the device-group snapshot comprises a device state for each of a plurality of devices in a source device group, wherein device states for the plurality of devices in the source device group comprise: (1) a device state of a cell phone and (2) a device state of a laptop computer, and wherein the device state of the laptop computer indicates that one or more applications are open on the laptop computer and the device state of the cell phone does not indicate that the one or more applications are open on the cell phone, and wherein the one or more applications open on the laptop computer comprise at least one of the following: (i) a word-processor application and (ii) a spreadsheet application;
responsive to receipt of the instruction to load the device-group snapshot, determining a target device group comprising one or more devices that are available to load the device-group snapshot, wherein the one or more devices available to load the device-group snapshot are configured to open the one or more applications that comprise at least one of the following: (i) the word-processor application and (ii) the spreadsheet application;
determining that there is a difference between the target device group and the source device group;
modifying the device-group snapshot based on the difference between the target device group and the source device group, wherein the modified device-group snapshot comprises a device state for each of the devices in the target device group; and
communicating with the one or more devices in the target device group to load the corresponding device states from the modified device-group snapshot.

2. The method of claim 1, wherein the computer-implemented method is carried out by a hub system with a head-mountable display (HMD).

3. The method of claim 1, wherein determining the target device group comprising the one or more devices that are available to load the device-group snapshot further comprises determining at least one of the following: (i) network connectivity of the one or more devices that are available to load the device-group snapshot, (ii) proximity of the one or more devices that are available to load the device-group snapshot, and (iii) ability to communicate with the one or more devices that are available to load the device-group snapshot.

4. The method of claim 1, wherein the source device group comprises at least one device that is unavailable in the target device group, and wherein modifying the device-group snapshot based on the difference between the target device group and the source device group comprises:
transferring at least a portion of the device state for the at least one device that is unavailable in the target device group to at least one device that is available in the target device group.

5. The method of claim 1, wherein the target device group includes at least one additional device not in the source device group, and wherein modifying the device-group snapshot based on the difference between the target device group and the source device group comprises:
transferring at least a portion of the device state for at least one device from the source device group to the at least one additional device in the target device group.

6. The method of claim 1, wherein the plurality of devices from the source device group are no longer available in the target device group, and wherein the target device group includes some devices from the source group as well as one or more additional devices, and wherein modifying the device-group snapshot based on the difference between the target device group and the source device group comprises:
transferring at least a portion of the device state for at least one device from the source device group that is no longer available in the target device group to the one or more additional devices in the target device group.

7. The method of claim 1, wherein no devices from the source device group are included in the target device group and wherein modifying the device-group snapshot based on the difference between the target device group and the source device group comprises:
transferring at least a portion of the device state for at least one device from the source device group to at least one device in the target device group.

8. The method of claim 1, further comprising:
determining a context based on the target device group and the source device group; and
using the context as a further basis for modifying the device-group snapshot.

9. The method of claim 8, wherein determining the context comprises determining one or more context signals.

10. The method of claim 9, wherein the one or more context signals comprise one or more of the following: (a) a current time, (b) a current date, (c) a current day of the week, (d) a current month, (e) a current season, (f) a time of a future event or future context, (g) a date of a future event or future context, (h) a day of the week of a future event or future context, (i) a month of a future event or future user-context, (j) a season of a future event or future context, (k) a time of a past event or past context, (l) a date of a past event or past context, (m) a day of the week of a past event or past context, (n) a month of a past event or past context, (o) a season of a past event or past context, (p) ambient temperature, (q) a current, future, or past weather forecast at a current location, (r) a current, future, or past weather forecast at a location of a planned event, (s) a current, future, or past weather forecast at or near a location of a previous event, (t) information on a calendar associated with a user-profile, (u) information accessible via a user's social networking account, (v) noise level or any recognizable sounds detected by a device, (w) devices that are currently available to a hub system, (x) devices in proximity to the hub system, (y) devices that are available to load the device-group snapshot, (z) information derived from cross-referencing any two or more of: information on the user's calendar, information available via the user's social networking account, and/or other context signals or sources of context information, (aa) health statistics or characterizations of the user's current health, (bb) a user's recent context as determined from sensors on or near the user and/or other sources of context information, (cc) a current location, (dd) a past location, and (ee) a future location.

11. A system comprising:
a non-transitory computer-readable medium; and
program instructions stored on the non-transitory computer-readable medium and executable by at least one processor to cause a wearable computer to:
receive an instruction to load a device-group snapshot, wherein the device-group snapshot comprises a device state for each of a plurality of devices in a source device group, wherein device states for the plurality of devices in the source device group comprise: (1) a device state of the wearable computer and (2) a device state of a second computer, and wherein the device state of the wearable computer indicates that one or more applications are open on the wearable computer and the device state of the second computer does not indicate that the one or more applications are open on the second computer, and wherein the one or more applications open on the wearable computer comprise at least one of the following: (i) a word-processor application and (ii) a spreadsheet application;
responsive to receipt of the instruction to load the device-group snapshot, determine a target device group comprising one or more devices that are available to load the device-group snapshot, wherein the one or more devices available to load the device-group snapshot are configured to open the one or more applications that comprise at least one of the following: (i) the word-processor application and (ii) the spreadsheet application;
determine that there is a difference between the target device group and the source device group;
modify the device-group snapshot based on the difference between the target device group and the source device group, wherein the modified device-group snapshot comprises a device state for each of the devices in the target device group; and
communicate with the one or more devices in the target device group to load the corresponding device states from the modified device-group snapshot.

12. The system of claim 11, wherein the wearable computer comprises a head-mountable display (HMD).

13. The system of claim 11, wherein the program instructions that cause the wearable computer to determine the target device group comprising the one or more devices that are available to load the device-group snapshot further cause the wearable computer to determine at least one of the following: (i) network connectivity of the one or more devices that are available to load the device-group snapshot, (ii) proximity of the one or more devices that are available to load the device-group snapshot, and (iii) ability to communicate with the one or more devices that are available to load the device-group snapshot.

14. The system of claim 11, wherein the source device group comprises at least one device that is unavailable in the target device group, and wherein the program instructions that cause the wearable computer to modify the device-group snapshot based on the difference between the target device group and the source device group further cause the wearable computer to:
transfer at least a portion of the device state for the at least one device that is unavailable in the target device group to at least one device that is available in the target device group.

15. The system of claim 11, wherein the target device group includes at least one additional device not in the source device group, and wherein the program instructions that cause the wearable computer to modify the device-group snapshot based on the difference between the target device group and the source device group further cause the wearable computer to:
transfer at least a portion of the device state for at least one device from the source device group to the at least one additional device in the target device group.

16. The system of claim 11, wherein the plurality of devices from the source device group are no longer available in the target device group, and wherein the target device group includes some devices from the source group as well as one or more additional devices, and wherein the program instructions that cause the wearable computer to modify the device-group snapshot based on the difference between the target device group and the source device group further cause the wearable computer to:
transfer at least a portion of the device state for at least one device from the source device group that is no longer available in the target device group to the one or more additional devices in the target device group.

17. The system of claim 11, further comprising program instructions stored on the non-transitory computer-readable medium and executable by the at least one processor to cause the wearable computer to:
determine a context based on the target device group and the source device group; and
use the context as a further basis for modifying the device-group snapshot.

18. The system of claim 17, wherein the program instructions that cause the wearable computer to determine the context based on the target device group and the source device group further cause the wearable computer to determine one or more context signals.

19. The system of claim 18, wherein the one or more context signals comprise one or more of the following: (a) a current time, (b) a current date, (c) a current day of the week, (d) a current month, (e) a current season, (f) a time of a future event or future context, (g) a date of a future event or future context, (h) a day of the week of a future event or future context, (i) a month of a future event or future user-context, (j) a season of a future event or future context, (k) a time of a past event or past context, (l) a date of a past event or past context, (m) a day of the week of a past event or past context, (n) a month of a past event or past context, (o) a season of a past event or past context, (p) ambient temperature, (q) a current, future, or past weather forecast at a current location, (r) a current, future, or past weather forecast at a location of a planned event, (s) a current, future, or past weather forecast at or near a location of a previous event, (t) information on a calendar associated with a user-profile, (u) information accessible via a user's social networking account, (v) noise level or any recognizable sounds detected by a device, (w) devices that are currently available to the wearable computer, (x) devices in proximity to the wearable computer, (y) devices that are available to load the device-group snapshot, (z) information derived from cross-referencing any two or more of: information on the user's calendar, information available via the user's social networking account, and/or other context signals or sources of context information, (aa) health statistics or characterizations of the user's current health, (bb) a user's recent context as determined from sensors on or near the user and/or other sources of context information, (cc) a current location, (dd) a past location, and (ee) a future location.

20. A non-transitory computer readable medium having stored therein program instructions executable by a first computing device to cause the first computing device to perform functions comprising:
receiving a user instruction to load a device-group snapshot, wherein the device-group snapshot comprises a device state for a plurality of devices in a source device group, wherein the device states for the plurality of devices in the source device group comprise: (1) a device state of the first computing device and (2) a device state of a second computing device, and wherein the device state of the first computing device indicates that one or more applications are open on the first computing device and the device state of the second computing device does not indicate that the one or more applications are open on the second computing device, and wherein the one or more applications open on the first computing device comprise at least one of the following: (i) a word-processor application and (ii) a spreadsheet application;
responsive to receipt of the instruction to load the device-group snapshot, determining a target device group comprising one or more devices that are available to load the device-group snapshot, wherein the one or more devices available to load the device-group snapshot are configured to open the one or more applications that comprise at least one of the following: (i) the word-processor application, and (ii) the spreadsheet application;
determining that there is a difference between the target device group and the source device group;
modifying the device-group snapshot based on the difference between the target device group and the source device group, wherein the modified device-group snapshot comprises a device state for each of the devices in the target device group;
communicating with the one or more devices in the target device group to load the corresponding device states from the modified device-group snapshot.

21. The non-transitory computer readable medium of claim 20, wherein the program instructions are further executable by a hub system with a head-mountable display (HMD).

22. The non-transitory computer readable medium of claim 20, wherein the program instructions for determining the target device group comprising the one or more devices that are available to load the device-group snapshot further cause the first computing device to perform functions comprising:
determining at least one of the following: (i) network connectivity of the one or more devices that are available to load the device-group snapshot, (ii) proximity of the one or more devices that are available to load the device-group snapshot, and (iii) ability to communicate with the one or more devices that are available to load the device-group snapshot.

23. The non-transitory computer readable medium of claim 20, wherein the source device group comprises at least one device that is unavailable in the target device group, and wherein the program instructions for modifying the device-group snapshot based on the difference between the target device group and the source device group further cause the first computing device to perform functions comprising:
transferring at least a portion of the device state for the at least one device that is unavailable in the target device group to at least one device that is available in the target device group.

24. The non-transitory computer readable medium of claim 20, wherein the target device group includes at least one additional device not in the source device group, and wherein the program instructions for modifying the device-group snapshot based on the difference between the target device group and the source device group further cause the first computing device to perform functions comprising:
transferring at least a portion of the device state for at least one device from the source device group to the at least one additional device in the target device group.

25. The non-transitory computer readable medium of claim 20, wherein the plurality of devices from the source device group are no longer available in the target device group, and wherein the target device group includes some devices from the source group as well as one or more additional devices, and wherein the program instructions for modifying the device-group snapshot based on the difference between the target device group and the source device group further cause the first computing device to perform functions comprising:
transferring at least a portion of the device state for at least one device from the source device group that is no longer available in the target device group to the one or more additional devices in the target device group.

26. The non-transitory computer readable medium of claim 20, further comprising program instructions for:
determining a context based on the target device group and the source device group; and
using the context as a further basis for modifying the device-group snapshot.

27. The non-transitory computer readable medium of claim 26, wherein the program instructions for determining the context based on the target device group and the source device group further cause the first computing device to determine one or more context signals.

28. The non-transitory computer readable medium of claim 27, wherein the one or more context signals comprise one or more of the following: (a) a current time, (b) a current date, (c) a current day of the week, (d) a current month, (e) a current season, (f) a time of a future event or future context, (g) a date of a future event or future context, (h) a day of the week of a future event or future context, (i) a month of a future event or future user-context, (j) a season of a future event or future context, (k) a time of a past event or past context, (l) a date of a past event or past context, (m) a day of the week of a past event or past context, (n) a month of a past event or past context, (o) a season of a past event or past context, (p) ambient temperature, (q) a current, future, or past weather forecast at a current location, (r) a current, future, or past weather forecast at a location of a planned event, (s) a current, future, or past weather forecast at or near a location of a previous event, (t) information on a calendar associated with a user-profile, (u) information accessible via a user's social networking account, (v) noise level or any recognizable sounds detected by a device, (w) devices that are currently available to a hub system, (x) devices in proximity to the hub system, (y) devices that are available to load the device-group snapshot, (z) information derived from cross-referencing any two or more of: information on the user's calendar, information available via the user's social networking account, and/or other context signals or sources of context information, (aa) health statistics or characterizations of the user's current health, (bb) a user's recent context as determined from sensors on or near the user and/or other sources of context information, (cc) a current location, (dd) a past location, and (ee) a future location.
